(19) United States
(12) Patent Application Publication
(10) Pub. No.: US 2016/0248099 A1
(43) Pub. Date: Aug. 25, 2016

(54) OXYGEN REDUCTION CATALYSTS

(71) Applicant: IMPERIAL INNOVATIONS LIMITED, London (GB)

(72) Inventors: Anthony Robert John Kucernak, London (GB); Thiago Lopes, London (GB); Daniel Malko, London (GB)

(21) Appl. No.: 15/026,004

(22) PCT Filed: Oct. 1, 2014
(86) PCT No.: PCT/EP2014/071094

§ 371 Date: Mar. 30, 2016

(30) Foreign Application Priority Data
Oct. 1, 2013 (GB) 1317412.3

(51) Int. Cl. H01M 4/90; H01M 4/92; H01M 8/1004; G01N 27/30; H01M 8/1023; H01M 8/1039; C25B 11/04; H01M 4/86; H01M 8/1007

(52) U.S. Cl. CPC H01M 4/9008; H01M 4/8657; H01M 4/925; H01M 8/1004; H01M 8/1007; H01M 8/1023; H01M 8/1039; C25B 11/0447; G01N 27/304; H01M 2004/8689; H01M 2008/1095

(57) ABSTRACT

The present invention relates to a method for preparing a catalyst which can be used to catalyse the oxygen reduction reaction (ORR). The invention also provides a catalyst obtained from the method and its use as an electrode, for example, in a galvanic cell, an electrolytic cell or an oxygen sensor.

### TECHNICAL FIELD

The present invention generally relates to the field of catalysts which are used for the reduction of oxygen.

### BACKGROUND

The oxygen reduction reaction (ORR) is a key reaction in numerous electrochemical processes. For example, polymer electrolyte fuel cells (PEFCs) may be operated on hydrogen and air (oxygen), and such fuel cells are considered a viable technology for powering vehicles. Furthermore, fuel cells operating on methanol, such as directed methanol fuel cells (DMFCs), involve the oxidation of methanol to carbon dioxide at the anode and the reduction of oxygen to water at the cathode. The ORR may also play an important in the chlorine industry. For example, chlorine electrolysis which uses an oxygen depolarised cathode has the possibility for significant reduction in energy over the current hydrogen evolution cathodes. Many oxygen reduction catalysts which might be used in this situation are adversely affected by chlorine and chloride ions.

In general, platinum supported on carbon is used to catalyse the ORR in industry. Platinum based catalysts are very expensive. In fact, the cost of the platinum catalysts is prohibitive in PEFCs, especially at the high loading require for the ORR.

Although carbon materials show some small activity towards oxygen reduction, especially in alkaline media, the reaction on carbon materials proceeds predominantly via two electrons, producing hydrogen peroxide, which is an unwanted side product, for example in fuel cell, as it reduces the power efficiency, and degrade system components.

O₂+2H⁺2e⁻⇄H₂O₂ (Equation 1)

One of the first attempts on developing new catalysts based on carbon molecules for the electrochemical reduction of oxygen reduction was carried out by Jasinski in 1964 (Jasinski, R., Nature 1964, 201 (4925), 1212-1213), where metal-phthalocyanines were shown to present promising catalytic activity, however with poor longevity. In the following years, this weakness was tackled and in 1978 Bagotzky et al. (Bagotzky, V. S. et al, Journal of Power Sources 1978, 2 (3), 233-240) found that both catalyst stability and activity could be improved by thermally treating, in an inert gas atmosphere, the metal-chelate molecule supported on carbon. As it would be expected that the chelate were to decompose at elevated temperatures, the research question in the next years was on understanding the nature of the active site or what happened to the Metal-N₄ catalytic site of the chelate after the heat treatment. Though strongly debated in this early period, this topic is still not completely understood today. However, in essence three models of the active site for the ORR on this heat treated materials stand to date, one each by van Veen, Yeager and Wiesener, and their respective collaborators (Dodelet, J.-P., Electrocatalysis in Fuel Cells, Shao, M., Ed. Springer London: 2013; Vol. 9, pp 271-338). For van Veen, it was proposed that the Metal-N₄ moiety remained intact during heat treatment, and was the active catalytic site. On the other hand Yeager and co-workers stated that N₄-metal-containing macrocycles are not necessarily needed for generating ORR active sites, concluding that the active site is different from the macrocycle-derived Metal-N₄ centres proposed by van Veen and co-workers. The structure C—Nₓ-Metal was assigned to be the catalytic site. In the third model, put forward by Wiesener, the metal was believed to act as a promoter of the active site by catalysing the formation of CNₓ, which would be the active site. For this model, the metal does not take a role in the oxygen reduction. In summary, the role of the metal on these materials was still in question.

This question has been tackled by researches during the years, aiming to assign the role of the metal on the formation of the active site and/or their role on the electroreduction of oxygen. In this matter, work carried out by the group of Dodelet in Canada stands out (Dodelet, J.-P., N4-Macrocyclic Metal Complexes, Eds. Springer New York: 2006; pp 83-147). In the 1990s, this group studied the influence of the metal reactant loading on the catalytic activity of this class of catalysts. By using very low loadings of either iron of cobalt, non-noble metal catalysts for the oxygen reduction reaction were synthesized and it was observed that there was an evidenced correlation between the catalytic activity and the metal loading up to 2 wt %. These findings were followed by spectroscopy studies aiming towards determining the nature of the active sites. With the use of Time-of-Flight Secondary Ion Mass Spectrometry (ToF-SIMS), the group of Dodelet proposed two structures to be the active sites on them catalysts, FeN₄/C and FeN₂/C (Jaouen, F. et al, Energy & Environmental Science 2011, 4 (1), 114-130). The first structure is in agreement with the catalytic site proposed by van Veen and the second is indirectly correlated to that proposed by Yeager, once the structure proposed by the latter group (C—Nₓ-Metal) acted only as a precursor to and not being the actual active site. Later, Dodelet's group proposed that the FeN₂/C was not the active site, but part of it, being in fact FeN₂₊₂/C. Here, nitrogen atoms of pyridinic character chelate the iron ions, in contrast to the active site proposed by Van Veen, where the nitrogen atoms are of pyrrolic character. The conclusion by this research group was that the metal is part of the active site for the electrochemical reduction of oxygen on these non-precious metal catalysts.

On the other hand, the model proposed by Wiesener in which the metal is not part of the active site has received attention more recently by some other research groups. However, issues with contamination by iron or the lower activity of metal-free catalysts compared to those synthesized with strategic addition of iron, leave open the question of the role of iron. It is noteworthy that even though this debate remains to date, Dodelet and collaborators have shown evidences to prove that iron might indeed take part on the active site for the electroreduction of oxygen. However, this group also express the possible existence of other site(s), supported on literature reports and which were thought to be metal-free.

In addition to catalytic activity, a further important feature of carbon based ORR catalysts is longevity. On this matter, the group of Zelenay in Los Alamos has achieved great progress. In an important contribution to the field, Wu et al. (Wu, G. et al, Science 2011, 332 (6028), 443-447) have produced carbon black supported catalysts based on polyaniline, cobalt and iron which, after heat treatments, present good stability under fuel cell tests, as well as considerable catalytic activity. Under a lifetime test at 0.4V and over 700 hours, this catalyst showed a decline in current of only 3%. This promising durability was attributed to the fact that cobalt usually leads to more graphitic nanostructures, which favours electronic conductivity and carbon corrosion. The carbon black was introduced in order to promote electrical conductivity of the catalyst.

Oxygen reduction reaction catalysts which are based on carbon nanotubes, graphene and carbon nitrides have also been investigated. Even though these catalysts are interesting from a fundamental point of view, attractive activities are almost only observed in alkaline media, where much cheaper nitrogen doped carbon blacks exhibit appreciable activity towards the oxygen reduction reaction (Zhang, S. et al, Electrocatalysis in Fuel Cells, Shao, M., Ed. Springer London: 2013; Vol. 9, pp 375-389). Another unfavourable feature of these catalysts is that materials such as carbon nanotubes require the intentional use of iron in their synthesis, which potentially results in a transition metal based catalyst, as shown by Li et al (Li, Y. et al, Nat Nano 2012, 7 (6), 394-400).

The use of transition metals such as iron, cobalt and copper in ORR catalysts is of concern for fuel cells as these metals catalyse hydroxyl radical formation in the presence of hydrogen peroxide, causing degradation of components, for instance the polymer electrolyte.

Another disadvantage in the use of platinum as a catalyst for the ORR is that these catalysts are susceptible to a wide range of poisons, which limits their utility in applications where such poisons may be present.

For Example, ORR catalysts could potentially be useful in oxygen sensors. However, platinum catalysts are highly susceptible to even tiny amounts of poisons such as hydrogen sulphide which may be present in the air streams to be tested, and exposure to these poisons often results in the irreversible deactivation of such catalysts.

A further problem associated with the use of platinum catalysts is that, in addition to catalysing the reduction of oxygen, they are capable of promoting other reactions which compete with the ORR. For example, platinum catalysts are capable of promoting both ORR as well as methanol oxidation. Therefore, in a methanol containing fuel cell, any methanol which crosses over from the anode to the cathode will undergo oxidation at the cathode, thereby reducing the power generated by the fuel cell, and increasing the consumption of methanol.

Platinum (either alone or alloyed with other elements), is the preferred catalyst for the ORR in Polymer Electrolyte Fuel Cells (PEFCs), but is also one of the rarer element on the earth. Hence the cost of platinum contributes significantly to the total cost of a PEFC. A reduction in the catalyst costs would make PEFCs significantly more financially viable.

There is therefore a need for oxygen reduction catalysts which are cheaper than conventional platinum catalyst. It is desirous that such catalysts do not promote the formation of hydrogen peroxide, or which are capable of catalysing reactions other than the ORR. It is also an aim of the invention to provide ORR catalysts which are less susceptible to poisons than the incumbent platinum-based catalysts.

### SUMMARY OF THE INVENTION

In a first aspect, the present invention relates to a method for preparing a catalyst, comprising the steps of:
a) Providing a reaction mixture comprising a precursor having:
   i. one or more aryl or heteroaryl rings and at least one amine group, —NHR, which is attached directly to the aryl or heteroaryl ring(s), wherein each R is independently selected from H, aliphatic, heteroaliphatic, aryl and heteroaryl; or
   ii. at least one heteroaryl ring comprising at least one nitrogen atom and/or at least one sulphur atom;
b) Polymerising the precursor; and
c) Heating the polymer produced by step b) to a temperature of between about 400° C. to about 1200° C.

In a first embodiment of the first aspect, the process is carried out in the absence of a porous (e.g. a microporous) support material. For example, when the precursor is the at least one heteroaryl ring comprising at least one nitrogen atom, the method may be carried out in the absence of a carbon support material. Preferably, when the precursor does not comprise a sulphur atom, the process is carried out in the absence of a porous (e.g. a microporous) support material.

In a second embodiment of the first aspect, a templating agent is added to the process prior to conducting step c). For example, the templating agent may be added to the reaction mixture of step a) or after step b) has been conducted. The templating agent comprises, consists essentially of or consists of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j.

In a third embodiment of the first aspect, the polymerisation step b) involves forming nanospheres of the polymerised precursor. This can be achieved, for example, by carrying out an emulsion or suspension polymerisation of the precursor. Thus, the third embodiment of the first aspect may comprise adding a surfactant to the reaction mixture of step a).

In a fourth embodiment of the first aspect, an iridium metal salt is added to the process prior to conducting step c). For example, the templating agent may be added to the reaction mixture of step a) or after step b) has been conducted.

The process of the first aspect may involve a combination of the first and second embodiments, the first and third embodiments, the first and fourth embodiments, the first, second and fourth embodiments, the first, third and fourth embodiments, the second and fourth embodiments or the second and third embodiments.

In a second aspect, the present invention relates to a catalyst obtainable by the method of the first aspect.

In a third aspect, the present invention provides an electrode comprising the catalyst according to the second aspect.

In a fourth aspect, the present invention provides a galvanic cell, such as a fuel cell or a battery or a redox flow battery comprising the catalyst according to the second aspect, or the electrode according to the third aspect.

In a fifth aspect, the present invention provides an electrolytic cell, for instance, a chlorine evolution cell comprising the catalyst according to the second aspect, or the electrode according to the third aspect.

In a sixth aspect, the present invention provides an oxygen sensor comprising the catalyst according to the second aspect, or the electrode according to the third aspect.

In a seventh aspect, the invention relates to a method for reducing oxygen, wherein the method is carried out in the presence of a catalyst according to the first aspect.

### BRIEF DESCRIPTION OF THE FIGURES

FIG. 1 shows a steady-state polarization curve for the electrochemical reduction of oxygen in 0.5M H₂SO₄, measured by the use of a rotating ring disk electrode. The bottom graph shows the oxygen reduction reaction (ORR) activity of the tested catalysts, and the respective hydrogen peroxide yields are shown in the top graph.

FIG. 2 shows a steady-state polarization curve for the electrochemical reduction of oxygen in 0.1 M NaOH, measured by the use of a rotating ring disk electrode. The bottom graph shows the oxygen reduction reaction (ORR) activity of the tested catalysts, and the respective hydrogen peroxide yields are shown in the top graph.

FIG. 3 shows the performance of a single Polymer Electrolyte Fuel Cell (PEFC) with a catalyst of the invention as the cathode versus that of a commercial platinum electrode.

FIG. 4 shows steady-state polarization curves for the electrochemical reduction of oxygen in 0.1 M NaOH in the presence of a catalyst according to the present invention without and with 1M methanol, measured by the use of a rotating ring disk electrode.

FIG. 5A shows steady-state polarization curves for the electrochemical reduction of oxygen in 0.5MH₂SO₄ without and in the presence of various concentrations of chloride ions, measured by the use of a rotating disk electrode. The top graph shows the results for a substantially metal-free catalyst of the present invention and the bottom graph sets out the results for carbon supported platinum.

FIG. 5B shows steady-state polarization curves for the electrochemical reduction of oxygen in 0.5M HCl in the presence of a catalyst according to the present invention without and in the presence of various concentrations of chlorine, measured by the use of a rotating disk electrode.

FIG. 6 is a comparison of the effect of hydrogen sulfide on a catalyst of the present invention versus that of a commercial platinum electrode (carbon supported platinum) when the hydrogen sulphide is present in the air stream of the PEFC.

FIG. 7 is a comparison of the effect benzene on a catalyst of the present invention versus that of a commercial platinum electrode (carbon supported platinum) when the benzene is present in the air stream of the PEFC.

FIG. 8A is a comparison of the effect of toluene on a catalyst of the present invention versus that of a commercial platinum electrode (carbon supported platinum) when the toluene is present in the air stream of the PEFC.

FIG. 8B shows steady-state polarization curves for the electrochemical reduction of oxygen in 0.5M H₂SO₄ in the presence of catalysts according to the present invention, measured by the use of a rotating ring disk electrode.

FIG. 9 shows a steady-state polarization curve for the electrochemical reduction of oxygen in 0.5M H₂SO₄, measured by the use of a rotating ring disk electrode, in the presence of non-precious metal doped catalysts. The bottom graph shows the oxygen reduction reaction (ORR) activity of the tested catalysts, and the respective hydrogen peroxide yields are shown in the top graph.

FIG. 10 shows a steady-state polarization curve for the electrochemical reduction of oxygen in 0.5M H₂SO₄, measured by the use of a rotating ring disk electrode, in the presence of precious metal doped catalysts. The bottom graph shows the oxygen reduction reaction (ORR) activity of the tested catalysts, and the respective hydrogen peroxide yields are shown in the top graph.

FIG. 11A shows a cyclic voltammogram trace for platinum supported on a catalyst according to the present invention, in N₂-saturated 0.5M H₂SO₄.

FIG. 11B shows steady-state polarization curves for the electrochemical reduction of oxygen in 0.5M H₂SO₄ in the presence of platinum supported on a catalyst according to the present invention, measured by the use of a rotating ring disk electrode.

FIG. 12 shows steady-state polarization curves for the electrochemical reduction of oxygen in 0.1M Na OH in the presence of a catalyst according to the present invention, measured by the use of a rotating ring disk electrode.

FIG. 13A shows an SEM image of self assembled nanospheres of the polymerised precursor, 1,5-diaminonaphthalene (ODIN) prior to heat treatment, and FIG. 13B shows an SEM image of the same product after heat treatment.

FIG. 14 shows a steady-state polarization curve for the electrochemical reduction of oxygen in 0.5M H₂SO₄ in the presence of a catalyst according to the present invention, measured by the use of a rotating ring disk electrode.

### DEFINITIONS

For the purpose of the present invention, an aliphatic group is a hydrocarbon moiety that may be straight chain or branched and may be completely saturated, or contain one or more units of unsaturation, but which is not aromatic. The term “unsaturated” means a moiety that has one or more double and/or triple bonds. The term “aliphatic” is therefore intended to encompass alkyl, alkenyl or alkynyl groups, and combinations thereof. An aliphatic group is preferably a C₁₋₂₀aliphatic group, that is an aliphatic group with 1, 2, 3, 4, 5, 6, 7, 8, 9, 10, 11, 12, 13, 14, 15, 16, 17, 18, 19 or 20 carbon atoms. Preferably, an aliphatic group is a C₁₋₁₅ aliphatic, more preferably a C₁₋₁₂ aliphatic, more preferably a C₁₋₁₀ aliphatic, even more preferably a C₁₋₈ aliphatic, such as a C₁₋₆ aliphatic group.

An alkyl group is preferably a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₅ alkyl, preferably a C₁₋₁₂ alkyl, more preferably a C₁₋₁₀ alkyl, even more preferably a C₁₋₈ alkyl, even more preferably a C₁₋₆ alkyl group. In certain embodiments, an alkyl group is a “C₁₋₆ alkyl group”, that is an alkyl group that is a straight or branched chain with 1 to 6 carbons. The alkyl group therefore has 1, 2, 3, 4, 5 or 6 carbon atoms. Specifically, examples of “C₁₋₂₀ alkyl group” include methyl group, ethyl group, n-propyl group, iso-propyl group, n-butyl group, iso-butyl group, sec-butyl group, tert-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like. Alkenyl and alkynyl groups are preferably “C₂₋₂₀ alkenyl” and “C₂₋₂₀ alkynyl” respectively, that is an alkenyl or alkynyl group which is a straight chain or branched chain with 2 to 20 carbons. The alkenyl or alkynyl group therefore has 2, 3, 4, 5, 6, 7, 8, 9, 10, 11, 12, 13, 14, 15, 16, 17, 18, 19 or 20 carbon atoms. Preferably, an alkenyl group or an alkynyl group is “C₂₋₁₅ alkenyl” and “C₂₋₁₅ alkynyl”, more preferably “C₂₋₁₂ alkenyl” and “C₂₋₁₂ alkynyl”, even more preferably “C₂₋₁₀ alkenyl” and “C₂₋₁₀ alkynyl”, even more preferably “C₂₋₈ alkenyl” and “C₂₋₈ alkynyl”, most preferably “C₂₋₆ alkenyl” and “C₂₋₆alkynyl” groups respectively.

A heteroaliphatic group is an aliphatic group as described above, which additionally contains one or more heteroatoms. Heteroaliphatic groups therefore preferably contain from 2 to 21 atoms, preferably from 2 to 16 atoms, more preferably from 2 to 13 atoms, more preferably from 2 to 11 atoms, more preferably from 2 to 9 atoms, even more preferably from 2 to 7 atoms, wherein at least one atom is a carbon atom. Particularly preferred heteroatoms are selected from O, S, N, P and Si. When heteroaliphatic groups have two or more heteroatoms, the heteroatoms may be the same or different.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Preferably, an alicyclic group has from 3 to 15, more preferably from 3 to 12, even more preferably from 3 to 10, even more preferably from 3 to 8 carbon atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substitutents, such as —CH₂— cyclohexyl.

Cycloalkyl, cycloalkenyl and cycloalkynyl groups have from 3 to 20 carbon atoms. The cycloalkyl, cycloalkenyl and cycloalkynyl groups therefore have 3, 4, 5, 6, 7, 8, 9, 10, 11, 12, 13, 14, 15, 16, 17, 18, 19 or 20 carbon atoms. Cycloalkyl, cycloalkenyl and cycloalkynyl groups preferably have from 3 to 15, more preferably from 3 to 12, even more preferably from 3 to 10, even more preferably from 3 to 8 carbon atoms. When an alicyclic group has from 3 to 8 carbon atoms, this means that the alicyclic group has 3, 4, 5, 6, 7 or 8 carbon atoms. Specifically, examples of the C₃₋₂₀ cycloalkyl group include cyclopropyl, cyclobutyl, cyclopentyl, cyclohexyl, cycloheptyl, adamantyl and cyclooctyl.

A heteroalicyclic group is an alicyclic group as defined above which has, in addition to carbon atoms, one or more ring heteroatoms, which are preferably selected from O, S, N, P and Si. Heteroalicyclic groups preferably contain from one to four heteroatoms, which may be the same or different. Heterocyclic groups preferably contain from 4 to 20 atoms, more preferably from 4 to 14 atoms, even more preferably from 4 to 12 atoms.

An aryl group is a monocyclic or polycyclic ring system having from 5 to 20 carbon atoms. An aryl group is preferably a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, naphthyl group or azulenyl group and the like. It should be noted that condensed rings such as indan and tetrahydro naphthalene are also included in the aryl group.

A heteroaryl group is an aryl group having, in addition to carbon atoms, from one to four ring heteroatoms which are preferably selected from O, S, N, P and Si. A heteroaryl group preferably has from 5 to 20, more preferably from 5 to 14 ring atoms. Specifically, examples of a heteroaryl group includes pyridine, imidazole, N-methylimidazole and 4-dimethylaminopyridine.

Examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, imidazolidine, indole, indoline, indolizine, indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

The term “halide” or “halogen” are used interchangeably and, as used herein mean a fluorine atom, a chlorine atom, a bromine atom, an iodine atom and the like, preferably a fluorine atom, a bromine atom or a chlorine atom, and more preferably a fluorine atom or a chlorine atom.

An alkoxy group is preferably a “C₁₋₂₀ alkoxy group”, more preferably a “C₁₋₁₅ alkoxy group”, more preferably a “C₁₋₁₂ alkoxy group”, more preferably a “C₁₋₁₀ alkoxy group”, even more preferably a “C₁₋₈ alkoxy group”, even more preferably a “C₁₋₆ alkoxy group” and is an oxy group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively. Specifically, examples of “C₁₋₂₀ alkoxy group” include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1,1-dimethylpropoxy group, 1,2-dimethylpropoxy group, 2,2-dimethylpropoxy group, 2-methylbutoxy group, 1-ethyl-2-methylpropoxy group, 1,1,2-trimethylpropoxy group, 1,1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group and the like.

An alkylthio group is preferably a “C₁₋₂₀ alkylthio group”, more preferably a “C₁₋₁₅ alkylthio group”, more preferably a “C₁₋₁₂ alkylthio group”, more preferably a “C₁₋₁₀ alkylthio group”, even more preferably a “C₁₋₈ alkylthio group”, even more preferably a “C₁₋₆ alkylthio group” and is a thio (—S—) group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively.

An alkylaryl group can comprise any of the alkyl or aryl groups discussed above. Preferably the alkylaryl group is a “C₆₋₁₂ aryl C₁₋₂₀ alkyl group”, more preferably a preferably a “C₆₋₁₂ aryl C₁₋₁₆ alkyl group”, even more preferably a “C₆₋₁₂ aryl C₁₋₆ alkyl group” and is an aryl group as defined above bonded at any position to an alkyl group as defined above. The point of attachment of the alkylaryl group to a molecule may be via the alkyl portion and thus, preferably, the alkylaryl group is —CH₂-Ph or —CH₂CH₂-Ph. An alkylaryl group can also be referred to as “aralkyl”.

An alkylheteroaryl group can comprise any of the alkyl or heteroaryl groups discussed above. Preferably the alkylheteroaryl group is a “heteroaryl C₁₋₂₀ alkyl group”, more preferably a preferably a “heteroaryl C₁₋₁₆ alkyl group”, even more preferably a “heteroaryl C₁₋₆ alkyl group” and is a heteroaryl group as defined above bonded at any position to an alkyl group as defined above. The point of attachment of the alkylheteroaryl group to a molecule may be via the alkyl portion. An alkylheteroaryl group can also be referred to as “heteroaralkyl”.

A silyl group is preferably a group —Si(R₇)₃, wherein each R₇ can be independently an aliphatic, heteroaliphatic, alicyclic, heteroalicyclic, aryl or heteroaryl group as defined above. In certain embodiments, each R₇ is independently an unsubstituted aliphatic, alicyclic or aryl. Preferably, each R₇ is an alkyl group selected from methyl, ethyl or propyl.

A nitrile group is a group CN.

An amino group is preferably —NH₂, —NHR₁₁ or —N(R₁₁)₂ wherein R₁₁ can be an aliphatic, heteroaliphatic, alicyclic, heteroalicyclic, a silylalkyl, aryl or heteroaryl group as defined above. It will be appreciated that when the amino group is N(R₁₁)₂, each R₁₁ group can be independently selected from an aliphatic, heteroaliphatic, alicyclic, heteroalicyclic a silylalkyl group, heteroaryl or an aryl group as defined above. In certain embodiments, each R₁₁ is independently an unsubstituted aliphatic, alicyclic or aryl. Preferably R₁₁ is methyl, ethyl, propyl, SiMe₃ or phenyl. When the amine group is an optional substituent for the precursor, it is preferably a group —N(R₁₁)₂.

An imine group is a group —CHNR₉ wherein R₉ is an aliphatic, heteroaliphatic, alicyclic, heteroalicyclic, aryl or heteroaryl group as defined above. In certain embodiments, R₉ is unsubstituted aliphatic, alicyclic or aryl. Preferably R₉ is an alkyl group selected from methyl, ethyl or propyl.

An amido group is preferably —NR₁₂C(O)— or —C(O)—NR₁₂— wherein R₁₂ can be hydrogen, an aliphatic, heteroaliphatic, alicyclic, heteroalicyclic, aryl or heteroaryl group as defined above. In certain embodiments, R₁₂ is unsubstituted aliphatic, alicyclic or aryl. Preferably R₁₂ is hydrogen, methyl, ethyl, propyl or phenyl.

An ester group is preferably —OC(O)R₁₃— or —C(O)OR₁₃— wherein R₁₃ can be hydrogen, an aliphatic, heteroaliphatic, alicyclic, heteroalicyclic, aryl or heteroaryl group as defined above. In certain embodiments, R₁₃ is unsubstituted aliphatic, alicyclic or aryl. Preferably R₁₃ is hydrogen, methyl, ethyl, propyl or phenyl.

A sulfoxide is preferably —SOR₁₄, a sulfonate group is preferably —OS(O)₂R₁₄, a sulfinate group is preferably —S(O)O—R₁₄, a sulphonate group is preferably —S(O)₂OR₁₄, wherein R₁₄ can be hydrogen, an aliphatic, heteroaliphatic, alicyclic, heteroalicyclic, aryl or heteroaryl group as defined above. In certain embodiments, R₁₄ is unsubstituted aliphatic, alicyclic or aryl. Preferably R₁₄ is hydrogen, methyl, ethyl, propyl or phenyl.

A carboxylate group is preferably OC(O)R₁₅, wherein R₁₅ can be hydrogen, an aliphatic, heteroaliphatic, alicyclic, heteroalicyclic, aryl or heteroaryl group as defined above. In certain embodiments, R₁₅ is unsubstituted aliphatic, alicyclic or aryl. Preferably R₁₅ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

A phosphinate group is preferably a group —OP(O)(R₁₇)₂ wherein each R₁₇ is independently selected from hydrogen, or an aliphatic, heteroaliphatic, alicyclic, heteroalicyclic, aryl or heteroaryl group as defined above. In certain embodiments, R₁₇ is aliphatic, alicyclic or aryl, which are optionally substituted by aliphatic, alicyclic, aryl or C₁₋₆alkoxy. Preferably R₁₇ is optionally substituted aryl or C₁₋₂₀ alkyl, more preferably phenyl optionally substituted by C₁₋₆alkoxy (preferably methoxy) or unsubstituted C₁₋₂₀alkyl (such as hexyl, octyl, decyl, dodecyl, tetradecyl, hexadecyl, stearyl).

An acetylide group contains a triple bond —C≡C—R₁₀, preferably wherein R₁₀ can be an aliphatic, heteroaliphatic, alicyclic, heteroalicyclic, aryl or heteroaryl group as defined above. For the purposes of the invention when R₁₀ is alkyl, the triple bond can be present at any position along the alkyl chain. In certain embodiments, R₁₀ is unsubstituted aliphatic, alicyclic or aryl. Preferably R₁₀ is methyl, ethyl, propyl or phenyl.

Any of the aliphatic, heteroaliphatic, alicyclic, heteroalicyclic, aryl, heteroaryl, haloalkyl, alkoxy, alkylthio, alkylaryl, ether, ester, sulfoxide, sulfonate, sulfinate, carboxylate, silyl ether, imine, acetylide, amino, alkylamino, phosphinate or amido groups wherever mentioned in the definitions above, may optionally be substituted by halogen, hydroxyl, nitro, carbonate, alkoxy, aryloxy, heteroaryloxy, amino, alkylamino, imine, nitrile, acetylide, or optionally substituted aliphatic, heteroaliphatic, alicyclic, heteroalicyclic, aryl or heteroaryl groups (for example, optionally substituted by halogen, hydroxyl, nitro, carbonate, alkoxy, amino, alkylamino, imine, nitrile or acetylide).

### DETAILED DESCRIPTION

The present invention is defined in the accompanying claims.

In a first aspect, the present invention relates to a method for preparing a catalyst, comprising the steps of:
a) Providing a reaction mixture comprising a precursor having
   i. one or more aryl or heteroaryl rings and at least one amine group, —NHR, which is attached directly to the aryl or heteroaryl ring(s), wherein each R is independently selected from H, aliphatic, heteroaliphatic, aryl and heteroaryl; or
   ii. at least one heteroaryl ring comprising at least one nitrogen atom and/or at least one sulphur atom;
b) Polymerising the precursor; and
c) Heating the polymer produced by step b) to a temperature of between about 400° C. to about 1200° C.

In a first embodiment of the first aspect, when the precursor does not comprise a sulphur atom, the method is carried out in the absence of a porous support material, e.g. a carbon support material. Preferably, the method of the first aspect is carried out in the absence of a microporous support (such as a carbon support material).

In a second embodiment of the first aspect (which may be in addition to the first embodiment of the first aspect), the process additionally comprises adding a templating agent to the process, prior to conducting step c), said templating agent comprising, consisting essentially of or consisting of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j. Preferably the templating agent comprises, consists essentially of or consists of a metal oxide, metal carbonate or metal bicarbonate. Preferably A is Mg or Ca.

It will be appreciated that the precursor of the first aspect may comprise one heteroaryl ring comprising at least one nitrogen atom. The precursor may comprise more than one heteroaryl ring comprising at least one nitrogen atom. For example, the precursor may comprise, 2, 3, 4, 5, 6 or more heteroaryl rings comprising at least one nitrogen atom.

The at least one heteroaryl ring comprising at least one nitrogen atom is preferably selected from pyridine, 2,2′bipyridine, phenanthroline, terpyridine, pyrrole, indole, pyrazine, pyrimidine, pyridazine, quinazoline, quinoline, or a triazine, preferably pyridine. The at least one heteroaryl ring comprising at least one nitrogen atom may optionally be substituted by one or more group selected from halogen, hydroxyl, nitro, amino, cyano, alkoxy, alkylthio, sulfonate, carboxylate, amido, aliphatic, heteroaliphatic, alicyclic, heteroalicyclic, aryl and heteroaryl.

It will also be appreciated that the precursor of the first aspect may comprise at least one heteroaryl ring comprising at least one sulphur atom. For example, the precursor may comprise 2, 3, 4, 5, 6 or more heteroaryl rings, the precursor comprising at least one sulphur atom. The precursor may comprise one heteroaryl ring comprising at least one sulphur atom.

The at least one heteroaryl ring comprising at least one sulphur atom may optionally be substituted by one or more group selected from halogen, hydroxyl, nitro, amino, cyano, alkoxy, alkylthio, sulfonate, carboxylate, amido, aliphatic, heteroaliphatic, alicyclic, heteroalicyclic, aryl and heteroaryl.

It will be appreciated by the skilled person that the precursor comprising at least one nitrogen atom or at least one sulphur atom may additionally comprise one or more aryl rings.

Preferably, the precursor of the first aspect comprises at least one nitrogen atom, even more preferably, the precursor comprises at least one nitrogen atom and at least one sulphur atom.

The skilled person will understand that when the precursor of the first aspect is at least one heteroaryl ring comprising at least one nitrogen atom and/or at least one sulphur atom, the precursor may additionally comprise at least one amine group, —NHR, which is attached directly to the heteroaryl ring(s), wherein each R is independently selected from H, aliphatic, heteroaliphatic, aryl and heteroaryl.

Preferably, the precursor of the first aspect comprises one or more aryl or heteroaryl rings and at least one amine group, —NHR, which is attached directly to the aryl or heteroaryl ring(s).

It will be understood that the precursor may comprise one aryl or heteroaryl ring. It will also be understood that the precursor may comprise more than one aryl or heteroaryl ring. For example, the precursor may comprise, 2, 3, 4, 5, 6 or more aryl or heteroaryl rings. The heteroaryl ring(s) may comprise one or more heteroatom, which may be nitrogen, sulphur or combinations thereof.

When the precursor comprises one aryl or heteroaryl ring, the aryl or heteroaryl ring is preferably selected from benzene or pyridine.

When the precursor comprises more than one aryl or heteroaryl ring, each of the rings may be an aryl ring, each of the rings may be a heteroaryl ring, or there may be a mixture of aryl and heteroaryl rings.

When the precursor comprises more than one aryl or heteroaryl ring, the rings may either be fused, or they may be joined by a linking moiety, or they may contain a mixture of both fused and joined aryl and/or heteroaryl rings.

Examples of linking moieties include a bond, alkylene, alkenylene, —S—, —S—S—, —O—, C═O, etc. Preferably, the linking moiety is a bond, C═O or —S—S—.

Examples of aryl or heteroaryl rings which are joined by a linking moiety include:

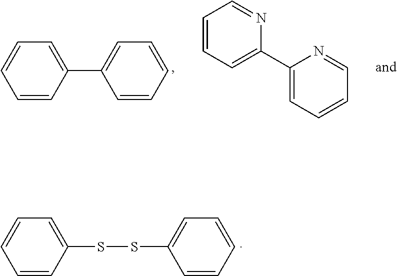

Examples of aryl or heteroaryl rings which are joined by a linking moiety and which contain fused aryl or heteroaryl rings include:

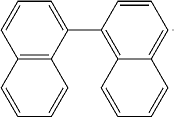 [SMILES: c1ccc2c(-c3cccc4ccccc34)cccc2c1]

Examples of fused aryl and/or heteroaryl rings include:

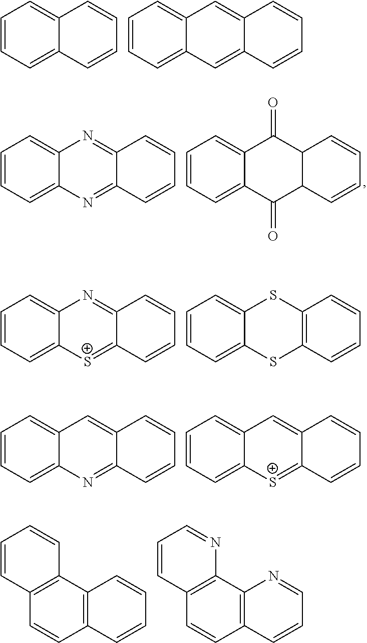

In particularly preferred embodiments, the one or more aryl or heteroaryl rings are selected from thionine, naphthalene, pyridine and benzene.

The skilled person will appreciate that the amine groups attached directly to the aryl or heteroaryl ring(s) of the precursor compound is represented by “—NHR”.

It will be appreciated that the precursor may comprise one —NHR group, for example, the precursor may be aniline.

It will also be appreciated that the precursor may comprise two —NHR groups. The skilled person will understand that the precursor may comprise more than two —NHR groups. For example, the precursor may comprise 2, 3, 4, 5, 6 or more —NHR groups, such as 2 or 3 —NHR groups.

Preferably, the precursor comprises one or two —NHR groups (e.g. one or two —NH₂ groups), more preferably the precursor comprises two —NHR groups (e.g. two —NH₂ groups).

Each R is independently selected from H, aliphatic, heteroaliphatic, aryl and heteroaryl. When R is not hydrogen, it is preferably selected from phenyl, C₁₋₆alkyl, C₂₋₆alkenyl, C₂₋₆alkynyl and pyridinyl, more preferably phenyl, C₁₋₆alkyl or C₂₋₆alkynyl. Preferably R is H, aryl, C₂₋₆alkynyl, C₁₋₆alkyl, more preferably R is H or phenyl.

In preferred embodiments, at least one R is H. For example, when the precursor comprises two —NHR groups, one R may be H and another R may be aryl. In further preferred embodiments, each R is H. When the precursor comprises one —NHR group, —NHR is preferably —NH₂. Preferably each —NHR group is —NH₂.

The —NHR group(s) is attached directly to the aryl or heteroaryl ring(s). The —NHR group may be attached at any position of the aryl or heteroaryl ring(s). The skilled person will appreciate that when the precursor comprises two or more aryl or heteroaryl rings, and the precursor comprises two or more —NHR groups, the —NHR groups may be attached to the same ring, or they may be attached to different rings.

In addition to the —NHR group(s), the aryl or heteroaryl ring(s) may be substituted by one or more groups selected from halogen, hydroxyl, nitro, amino, cyano, alkoxy, alkylthio, sulfonate, carboxylate, amido, aliphatic, heteroaliphatic, alicyclic, heteroalicyclic, aryl and heteroaryl.

Preferably the precursor is optionally substituted by nitro, halogen, cyano, C₁₋₆alkyl, C₂₋₆alkenyl, C₂₋₆alkynyl, sulfonate, or C₁₋₆alkoxy.

The skilled person will appreciate that it is preferred for the precursor to comprise one or more ary or heteroaryl ring(s), and be substituted by at least one (e.g. 2 or 3) —NHR group(s), at least one of said —NHR groups preferably being —NH₂. Preferably, the precursor may be a diaminonaphthalene (e.g. 1,5-diaminonapthalene, 1,8-diaminonaphthalene, 2,3-diaminonaphthalene), a di- or triaminobenzene (e.g. Optionally substituted by hydroxyl, alkyl, alkoxy, halide, nitro or sulphonate), a diamino pyridine (e.g. 2,6-diaminopyridine or 2,3-diaminopyridine), a diaminoanthraquinone (e.g. 1,4-diaminoanthraquinone or 1,5-diaminoanthraquinone), a diaminobiphenyl, a diaminobinaphthyl, a diaminophenazine, dithioaniline or thionine.

In particularly preferred embodiments of the first aspect, the precursor is selected from:

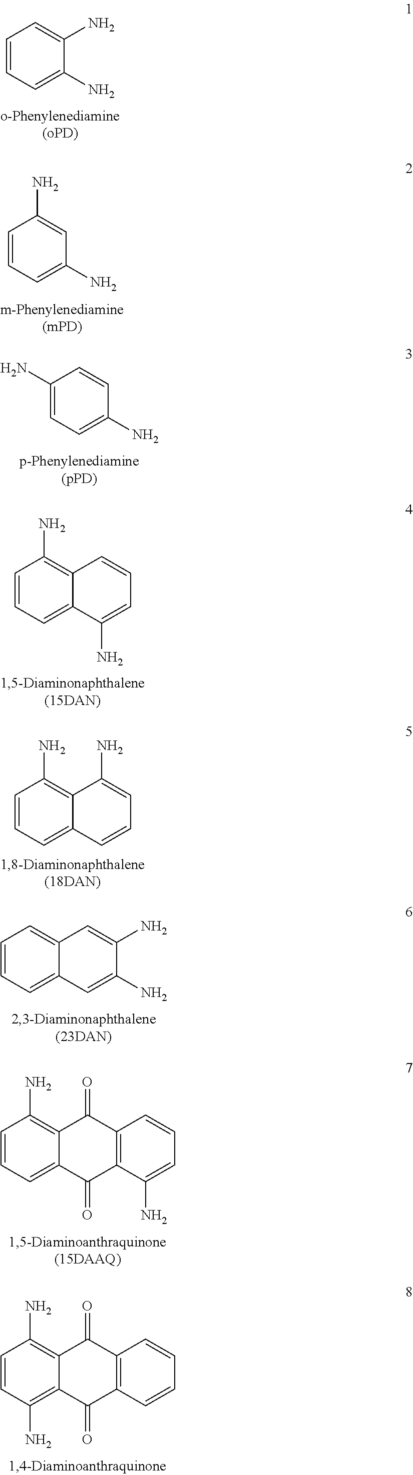

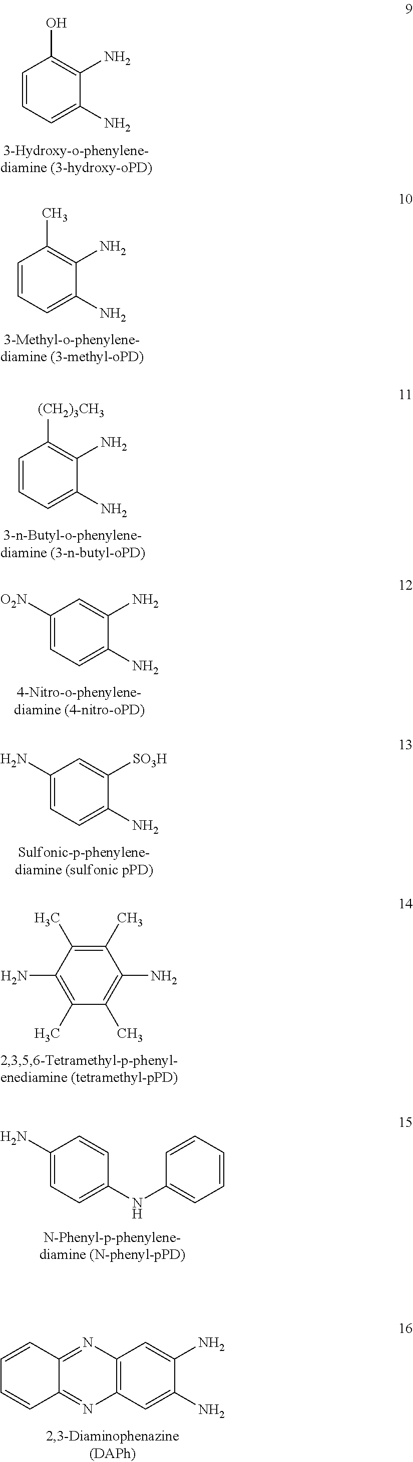

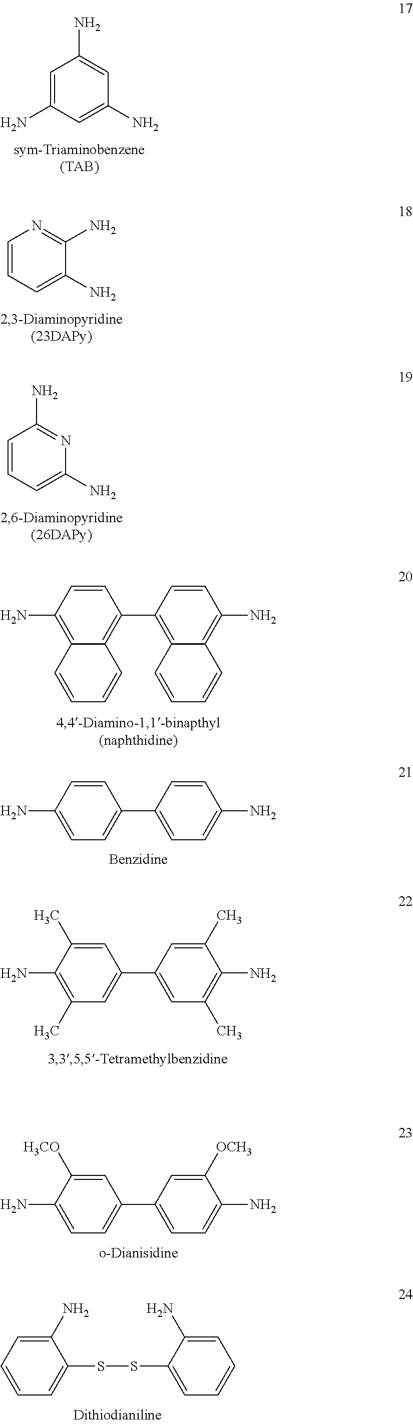

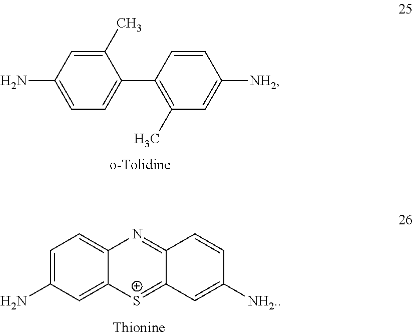 [SMILES: Cc1cc(N)ccc1-c1ccc(N)cc1C ; Nc1ccc2nc3ccc(N)cc3[s+]c2c1]

More preferably, the precursor is selected from 1,5-diaminonaphthalene, 1,2-diaminobenzene, thionine and 1,2-diaminopyridine.

The skilled person will understand that when the precursor comprises a cation (e.g. thionine), it will also comprise a counterion. In other words, the precursor may be a salt. Suitable counterions are well known to the skilled person. For example, the counterion may be a halide (such as Cr, Br, etc), a carboxylate (e.g. R^{c}CO₂⁻, wherein R^{c} is H or an optionally substituted alkyl, alkenyl, aryl or hereoaryl), OH⁻, or a mixture thereof.

It will be appreciated that the various preferred features described above for the precursor may be present in combination mutatis mutandis.

The mixture of step a) of the first aspect may comprise a solvent. Examples of suitable solvents include water and alcohols such as methanol, ethanol, butanol, propanol and pentanol, formamide, dimethyl formamide, cholorinated aliphatic compounds (e.g. dichloromethane, dichloroethane), alkanes such as pentane, hexane, etc, dimethyl sulphoxide, dimethyl carbonate, propylene carbonate or mixtures thereof.

As discussed above, when the precursor does not comprise a sulphur atom, the process of the first aspect is carried out in the absence of a support material. ORR catalysts of the prior art are typically produced by polymerising a nitrogen containing precursor in the presence of a conductive carbon containing support material. The conductive carbon support material is used to enhance the conductivity of the resultant catalyst. Typically the prior art catalysts cannot be used for ORR unless they comprise a conductive carbon support. However, the inventors of the present application have prepared and tested catalysts which can be produced in the absence of a support, and which have sufficient conductivity to allow them to be used to catalyse ORR.

While other porous support materials have been suggested (for example, US2014/0011673), it is generally accepted that if the resultant material is to be used as an ORR catalyst, a conductive support material is required, Furthermore, non-conductive supports such as silicone dioxide are generally difficult to remove post-synthesis, and require harsh chemical reagents, such as a strong base and/or HF.

Thermally decomposable support materials have been suggested in WO2012/107838, including metal organic frameworks (MOFs) and zeolite imidazolate frameworks (ZIFs). The materials used in WO2012/107838 have a high degree of microporosity and are pyrolised in the process of making the catalysts referred to therein. Thus, a significant portion of the material is left behind after pyrolysis has taken place, and the framework is incorporated into the resultant catalyst, that is, the support is pyrolised into the catalyst. In other words, the supports can be regarded as “active” templates. Furthermore, the types of frameworks suggested in WO2012/107838 are costly and can significantly impact the cost of the catalyst produced therefrom.

When the precursor is pyridine or a polypyridine, preferably when the precursor is the at least one heteroaryl ring comprising at least one nitrogen atom, the reaction mixture does not comprise a support material (e.g. a carbon support material). Examples of such carbon support materials include carbon black, carbon paper, carbon cloth, carbon felt, graphite, carbon nanotubes, carbon nano- or microfibers, and mixtures thereof.

In further preferred embodiments, the reaction mixture does not comprise a porous support material. The term “porous support material” includes microporous support materials, such as silicone dioxide, zeolites, a carbon support material as defined above, and the types of supports referred to in WO2012/107838.

The process of the first aspect can produce materials which can be used as ORC catalyst by following steps a) to c) above. However, the activity of the catalysts produced by the process of the first aspect can be improved by adding a templating agent to the reaction mixture of step a). The templating agent comprises, consists essentially of or consists of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 metal, i is the charge on the metal A, X is a counterion selected from an oxide, hydroxide, carbonate, bicarbonate, nitrate, oxalate, formate, acetate or sulphate, j is the charge on the counterion and i=n×j.

Preferably the templating agent comprises, consists essentially of or consists of a metal oxide, metal carbonate or metal bicarbonate.

Preferably, the metal is an alkaline earth metal, such as Mg, Ca, Sr or Ba. Preferably X is oxide, carbonate or bicarbonate. Even more preferably the templaing agent comprises, consists essentially of or consists of MgO, CaO, MgCO₃ or CaCO₃. Even more preferably, the templaing agent comprises, consists essentially of or consists of MgO.

The templating agent is a nanopowder. The particles of the nanopowder preferably have a mean longest diameter of from about 1 to about 1000 nm, preferably from about 5 to about 500 nm, more preferably from about 10 to about 200 nm, e.g. from about 15 to about 100 nm. Preferably the mean longest diameter is about 50 nm or less (e.g. from about 1 to about 50 nm).

The templating agent is capable of imparting structure to the resultant catalyst. For example, the templating agent may increase the surface area of the resultant catalyst and/or improve certain morphological features, such as the ratio of meso and microporosity.

The templating agents defined above are simple and cheap to remove post-synthesis. For example, the templating agent may be removed by refluxing in the presence of an acid (e.g. sulphuric acid).

Therefore in a second embodiment of the first aspect, the process of the first aspect involves adding a templating agent to the reaction mixture of step a), wherein the templating agent is as defined above. It will be appreciated by the skilled person that the second embodiment of the first aspect may also be combined with the first embodiment of the first aspect (e.g. conducting the process of the first aspect in the absence of a porous support, such as a microporous support material).

The templating agent may be added in an amount of from about greater than zero:1 to about 3:1, relative to the precursor, preferably from about 0.05:1 to about 2.5:1, relative to the precursor, more preferably from 0.1:1 to 2:1, relative to the precursor. For example the ratio of templating agent to precursor may be about 1:1. The ratios mentioned here are weight ratios.

When the reaction mixture of step a) comprises a templating agent, the reaction mixture may additionally comprise a solvent. When a templating agent is present, the solvent is preferably a non-solvent for said templating agent. By “non-solvent”, it is meant that the templating agent is substantially not dissolved by the solvent, e.g. greater than 95 wt %, preferably greater than about 98 wt %, more preferably greater than about 99 wt %, more preferably greater than about 99.5 wt % of the templating agent is not dissolved by the solvent at the temperature at which the reaction is being carried out (e.g. room temperature (about 25° C.)). When the templating agent is an oxide, bicarbonate or carbonate, the non-solvent may be water or an alcohol (e.g. MeOH or EtOH). The non-solvent may be a non-polar organic solvent such as toluene or hydrocarbon(s), a polar aprotic solvent, such as acetonitrile or chlorinated hydrocarbon(s), or a polar protic solvent.

The polymerisation reaction of step b) of the first aspect may be initiated by an oxidising agent. Therefore, the mixture of step a) of the first aspect may comprise an oxidising agent which is capable of initiating the polymerisation of the precursor. Suitable oxidising agents include iodine, sodium persulfate, potassium persulfate, ammonium persulfate, ozone radical initiators, nitrate salts, and horseradish peroxidase, hydrogen peroxide, halogens such as chlorine, bromine or iodine, sodium hypochlorite, potassium hypochlorite.

For example, the polymerisation of step b) of the first aspect may be initiated by a radical initiating species. Therefore, the mixture of step a) of the first aspect may comprise an initiating compound which, when subjected to UV radiation, decomposes to form a radical initiating species. Examples of suitable initiating compounds include organic peroxides and hydroperoxides, sodium persulfate, potassium persulfate, ammonium persulfate, peroxyphosphates.

Alternatively, the polymerisation of step b) of the first aspect may be an electrochemical oxidative polymerisation. Electrochemical polymerisation may be carried out in an electrochemical cell. In such electrochemical cells, one electrode (working electrode) may be polarised relative to a second electrode (counter electrode). In addition, a third electrode (reference electrode) may be used to monitor the electrochemical potential applied to the working electrode. The working electrode is usually chosen to be either a noble metal (e.g. platinum, gold, palladium) or a material which does not undergo decomposition during the electrochemical reaction, for example, carbon, more specifically graphite or glassy carbon, tin dioxide, doped diamond (e.g. doped with boron). Similarly the counter electrode may be made of one of the materials described above, chosen so as to avoid decomposition and contamination of the solution.

Electrochemical polymerisation may be initiated by polarising the working electrode in a solution which comprises the precursor. The electrochemical potential is preferably chosen so as to lead to electrochemical oxidation and subsequent polymerisation of the precursor. In order to improve the efficiency of the electrochemical process, an electrolyte may be added to the solution. The electrolyte improves ionic conduction within the solution, and is usually chosen to not react with the precursor or resultant polymer. Examples of electrolytes include common acids and bases and their corresponding salts, such as nitric, sulphuric, phosphoric, perchloric, hydrochloric, hydroiodic, hydrofluoric acids and potassium, sodium, calcium, ammonium, lithium, magnesium hydroxide. For example, magnesium hydroxide may be added to HCl, and the resulting magnesium chloride may be used as an electrolyte. For non-aqueous solutions, examples include tetra-alkyl ammonium or lithium cations paired with anions such as hexafluorophosphate, tetrafluoroborate, perchlorate etc.

Alternatively, polymerisation may be achieved by utilising a plasma. The plasma polymerisation process utilises a gaseous or liquid precursor and exposes said precursor to an electrical or radio frequency excited gas discharge which in polymerisation of the precursor.

The polymerisation reaction of step b) of the first aspect may be carried out under acidic conditions, alkaline conditions or neutral reaction conditions. Therefore, the skilled person will appreciate that the reaction mixture of step a) of the first aspect may comprise an acid or an alkali. Examples of suitable acids include nitric acid (HNO₃). The acid or alkali may be provided in any concentration, for example, about 0.01 to about 2M, such as about 0.1 to about 1M.

The polymerisation reaction of step b) of the first aspect may be carried out at a temperature of between about −10° C. to about 150° C., preferably between about 0° C. to about 120° C. Preferably the reaction is carried out without applying additional heat to the reaction mixture. In other words, the reaction can be carried out at room temperature, for example, at a temperature of between about 15° C. to about 30° C.

The duration of the polymerisation reaction can be up to about 48 hours, preferably from about 0.5 hours to about 36 hours, for example from about 1 hour to about 24 hours. The reaction mixture may be stirred prior to and/or during the polymerisation reaction.

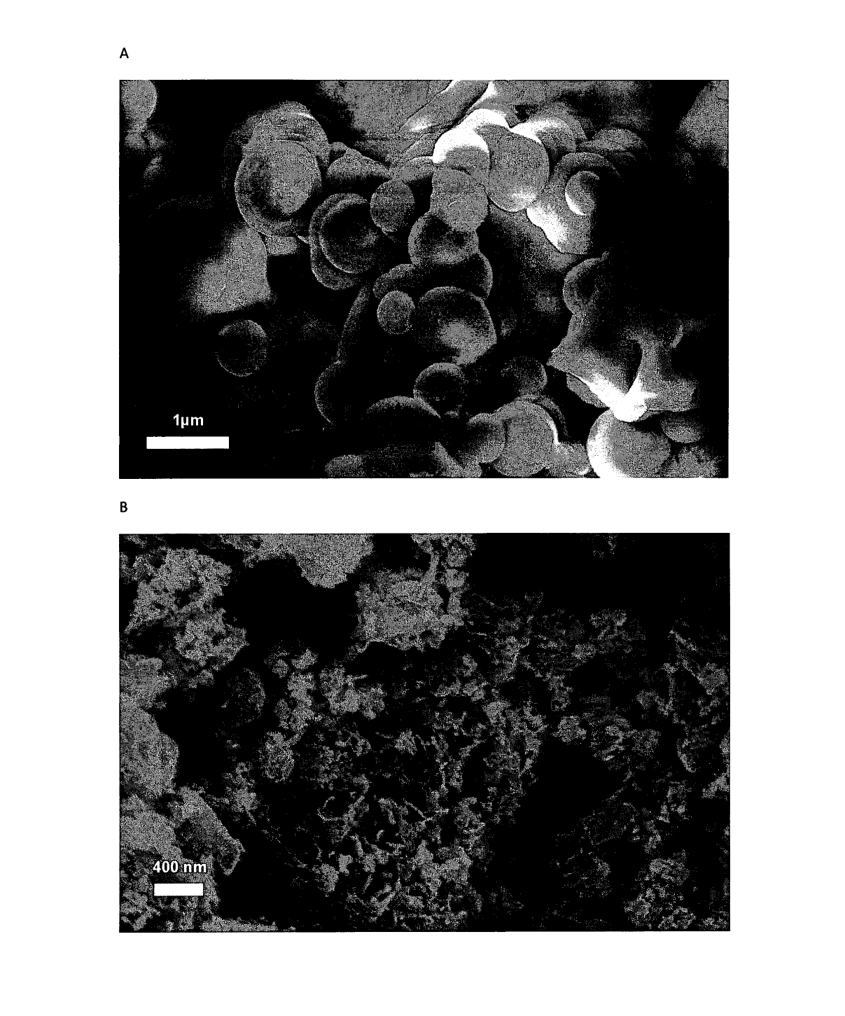

It has been found that a number of the precursors of the first aspect are capable of self assembly to form polymer “nanospheres” during the polymerisation process. The size of these nanospheres will depend on the reaction conditions and the nature of the precursor. However, it is generally preferred that the nanospheres have a longest mean diameter of from about 0.05 to about 2 μm, preferably from about 0.1 to about 0.9 μm. When these nanospheres are pyrolised, they form structures which generally retain the nanosphere size and shape, but which are also highly porous themselves. The hierarchy of pore sizes is understood to be important in obtaining a catalyst with good activity, as it is believed to increase the access of the reactant to the high surface area of the material. The precursors which are understood to self assemble under single phase conditions, once polymerised, include 1,5-diaminonaphthalene. FIG. 13A shows an SEM image of self assembled microspheres of the polymerised precursor, 1,5-diaminonaphthalene (ODIN) prior to heat treatment, and FIG. 13B shows an SEM image of the material after heat treatment. The nanospheres can clearly be seen in FIG. 13A, and FIG. 13B shows how the microstructure of the product is largely maintained, after heat treatment. The skilled person will also appreciate that the precursor may self assemble to form nanofibres, preferably having an mean longest diameter of about the same dimensions as the nanospheres.

It is also possible to prepare polymer “nanospheres” of the precursors by using polymerisation techniques such as emulsion polymerisation and suspension polymerisation. Emulsion and suspension polymerisations are well known to the person skilled in the art. Thus the process of the first aspect may involve forming a dispersion of droplets comprising the precursor prior to and/or during the polymerisation step b).

Examples if suitable emulsion polymerisations include an oil-in-water or water-in-oil emulsion. Therefore, in a third embodiment of the first aspect, the process may involve forming an emulsion of the precursor, prior to and/or during the step of polymerising the precursor. It will be understood that the mixture of step a) may additionally comprise a surfactant, and optionally the two phases to form the emulsion. Suitable surfactants include anionic, cationic and non-ionic surfactants, such as fatty acids, sodium lauryl sulphate (SDS), alpha olefin sulfonate and polyvinylpyrrolidone (PVP), preferable the surfactant is SDS. Suitable two-phase systems include aqueous/propylene carbonate, aqueous/non-polar organic solvent and aqueous/polar aprotic solvent. It will be appreciated that when a surfactant is present, the second phase of the emulsion may be omitted. Emulsion polymerisation of 1,5-diaminonaphthalene has previously been carried out by Li, Xin-Gui et al (Chemistry, CHEM. EUR. J. 2012, 18, 9877-9885). The polymerisation may be a suspension polymerisation, which may involve mechanical agitation to mix the precursor and solvent prior to and/or during the polymerisation step b).

Once the polymer nanospheres have been produced, they may be separated from the reaction mixture, for example, by centrifugation or filtration. It will be appreciated that when the polymer nanospheres are formed by self assembly or by emulsion polymerisation, a templating agent may be omitted.

Once the polymerisation step of the first aspect has taken place, any solvent which may have been present in the reaction mixture of step a) may optionally be removed prior to carrying out step c) of the first aspect. This may be achieved in any number of ways, for example, by filtration, centrifugation, heating or applying a vacuum. This skilled person will appreciate that a combination of these methods may be used, for example, by heating and applying a vacuum to the product of step b) of the first aspect, or both.

It will be appreciated by the skilled person that it is not necessary to include metals in the process of the first aspect in order to obtain catalysts having good catalytic activity for ORR. Therefore, the method of the first aspect may result in the production of a substantially metal-free catalyst. The term “substantially metal free” is intended to refer to catalysts which contain no or contain only trace amounts of metals (i.e. <0.9 wt %, such as <0.5 wt %, preferably <0.1 wt % of total metals). However, the skilled person will appreciate that while the reaction can be carried out without adding any additional metal-containing species, the reactants may comprise metal impurities. Furthermore, certain polymerisation reactions which are contemplated for use in step b) of the first aspect may be catalysed or promoted by the addition of small amounts of metal-containing species. Therefore, in preferred embodiments, the reaction mixture used in the method of the first aspect comprises less than about 0.9 wt %, preferably less than about 0.5 wt %, preferably less than about 0.2 wt %, preferably less than about 0.1 wt %, even more preferably less than about 0.08 wt % of metal.

The method of the first aspect may additionally comprise the step of removing any metal-containing compounds from the result of step b), prior to carrying out step c).

The step of removing any metal-containing compounds may comprise washing the result of step b) with a metal removing agent. Examples of suitable metal removing agents include aqueous acids, for example mineral acids such as hydrogen halides (HCl, HBr, HI), perchloric acid, chloric acid, nitric acid and sulphuric acid, or organic acids, such as formic acid, acetic acid and benzoic acid. Other examples of metal removing agents include any compound which can bond to, complex to, or otherwise remove a metal cation, such as ammonium or alkaline metal carboxylates (e.g. ammonium, sodium or potassium salts of tartrate, citrate, oxalate, formate, acetate, malonate, malate, succinate, EDTA and the like), or basic solutions of a polyol (e.g. base-sugar mix, base-glycol mix, base-triethanol amine mix and the like).

In certain embodiments of the first aspect, steps a) and b), and/or step c) take place without adding a metal or a metal-containing compound.

However, the skilled person will also appreciate that the activity of the catalysts produced by the first aspect of the invention may be enhanced by adding a metal or a metal-containing compound to the process of the first aspect, prior to the pyrolysis step c). For example, said compound may be added to the reaction mixture of step a), or to the result of the polymerisation step b).

For example, a non-precious metal or non-precious metal salt may be added prior to step c) of the first aspect, for example it may be added to the reaction mixture of step a) of the first aspect or after step b) has been conducted. Suitable non-precious metals include cobalt, iron, manganese and chromium. Thus, suitable non-precious metal salts include halides, such as chloride, hydrides, carbonates, bicarbonates, nitrates, phosphates, cyanide, sulphates, formates, ammonium, acetates and mixtures thereof. It will be appreciated that organometallic complexes of the above metals are included in the definition of “salts”. Preferably, the salt is a halide (preferably a chloride) of Co, Fe, Mn or Cr. Exemplary non-precious metal salts include FeCl₂, CoCl₂, CrCl₃ and MnCl₂. The skilled person will appreciate that the non-precious metal salts may be associated with water of hydration molecule(s).

It will also be appreciated that a precious metal or precious metal salt may be added prior to step c) of the first aspect, for example, it may be added to the reaction mixture of step a) of the first aspect, or after step b) has been conducted. Suitable precious metals include iridium, ruthenium, rhodium, rhenium, osmium, palladium and platinum. Thus, suitable precious metal salts include halides, such as chloride, hydrides, carbonates, bicarbonates, nitrates, phosphates, cyanide, formate, ammonium, sulphates, acetates, and mixtures thereof. It will be appreciated that organometallic complexes of the above metals are included in the definition of “salts”. Preferably, the salt is a halide (preferably a chloride) of Ir, Rh, Ru, Re, Os, Pd or Pt, preferably Ir, Ru, Rh or Pt, more preferably Ir. Exemplary precious metal salts include IrCl₃, RhCl₃, RuCl₃, Ir(mppy)₃, (NH₄)₃IrCl₆, (NH₄)₂IrCl₆, Ir₄(CO)₁₂, IrCl(CO)[P(C₆H₅)₃]₂, and H₂IrCl₆. The skilled person will appreciate that the precious metal salts may be associated with water of hydration molecule(s).

The precious metal or non-precious metal, or salt thereof (preferably a salt of a precious metal or non-precious metal), may be added to the process of the first aspect in an amount of about 0.02 to about 10% by weight of metal, preferably about 0.05 to about 5% by weight of metal, more preferably from about 0.1 to about 2% by weight of metal, more preferably from about 0.5 to about 1.5% by weight of metal, compared to the total weight of the precursor. When the precious metal or non-precious metal is provided as a salt, it is preferably dissolved in a solvent prior to addition. For example, it may be dissolved in a solvent and then added to the reaction mixture of step a) or added to the reaction mixture after step b) has been conducted. Suitable solvents include alcohols (e.g. methanol or ethanol), water, acetone etc.

The inventors have surprisingly found that catalysts prepared by the process of the first aspect in which a salt of iridium has been added to the reaction mixture of the first aspect have activity for ORR which is comparable to that of Pt/C. Thus, in a fourth embodiment of the first aspect, the process of the first aspect involves adding an iridium salt (preferably an iridium chloride) to the reaction mixture of the first aspect. The iridium salt may be added to the reaction mixture of step a), e.g. prior to step b) being conducted, or it may be added to the reaction mixture after step b) has been conducted. Exemplary iridium salts include IrCl₃, Ir(mppy)₃, (NH₄)₃IrCl₆, (NH₄)₂IrCl₆, Ir₄(CO)₁₂, IrCl(CO)[P(C₆H₅)₃]₂, and H₂IrCl₆. The skilled person will appreciate that the precious metal salts may be associated with water of hydration molecule(s).

The skilled person will understand that the fourth embodiment of the first aspect may be combined with the first embodiment, the second embodiment or the third embodiment of the first aspect. It may also be combined with the first and second, or first and third embodiment of the first aspect.

It will be appreciated that while iridium is a precious metal, the amount of precious metal in the catalyst is much less than the incumbent Pt/C catalysts, and yet achieve comparable activities for the ORR.

Step c) of the method of the first aspect involves heating the product of step b) in order to produce a catalytic species. This is achieved by heating the polymer produced by step b) of the first aspect to a temperature of between about 400° C. to about 1200° C. Preferably the polymer is heated to a temperature of between about 600° C. to about 1100° C., more preferably to a temperature of between about 700° C. to about 1050° C., for example, at a temperature of about 800° C., about 900° C., or about 1000° C. In particularly preferred embodiments, the heating is carried out at about 1000° C. Heating is performed for at least about 15 minutes, preferably for a time between about 30 minutes and about 4 hours, for example for a time of about 2 hours.

The step of heating may be performed under a heating ramp from about 5° C. min⁻¹ to about 50° C. min⁻¹. The skilled person will appreciate that it will be necessary to apply heat to the polymer produced by step b) of the first aspect in order to get up to the desired temperature in the range of between about 400° C. to about 1200° C. This heat can be applied at a rate of between about 5° C. min⁻¹ to about 50° C. min⁻¹, more preferably between about 10° C. min⁻¹ to about 40° C. min⁻¹, such as about 15° C. min⁻¹ to about 25° C. min⁻¹, e.g. about 20° C. min⁻¹.

Step c) of the first aspect may be carried out under vacuum. Alternatively, step c) of the first aspect may be carried out in the presence of a gas. The gas may be selected from nitrogen (N₂), argon, helium, hydrogen, ammonia or a mixture thereof. Preferably the gas is a nitrogen-containing gas, such as ammonia or N₂. The pressure of the gas may be from about 0.1 atmosphere to about 5 atmospheres.

It will be appreciated that the various preferred features described above for the method of the first aspect may be present in combination mutatis mutandis.

In a second aspect, the present invention relates to a catalyst obtainable by the method of the first aspect.

In a third aspect, the present invention provides an electrode comprising the catalyst according to the second aspect.

The catalysts produced by the process of the first aspect can be used to support platinum. Thus, it is possible to deposit platinum on a catalyst produced by the process of the first aspect and subsequently use said catalyst to catalyse the ORR. While such a catalyst does contain platinum, it is understood that in view of the ability of the ability of the catalysts produced by the first aspect to catalyse the ORR, much less platinum is required to achieve the same activity as the incumbent Pt/C catalysts. Thus, the catalysts produced by the first aspect can effectively be used to “thrift” away platinum from ORR catalysts.

Therefore, in a preferred embodiment of the third aspect, the electrode additionally comprises platinum, said platinum preferably being deposited on the catalyst of the second aspect. The platinum may be deposited on the catalysts produced by the process of the first aspect using standard platinum deposition methods known in the art. For example, such methods include chemical vapour deposition, physical vapour deposition (e.g. sputtering), plasma deposition, oxidation of platinum to a platinum oxide sol, followed by reduction, etc. Suitable deposition methods are set out, for example, in Esmaeilifar, A., et al (Energy, 2010, 35, 3941-3957) or Wee. J. H., et al (Journal of Power Sources, 2007, 165, 667-677).

It will be appreciated that platinum can be deposited on the catalysts of the invention by adding a solution of a platinum salt (e.g. H₂PtCl₆) to a dispersion of the inventive catalyst in solution, or to the dry catalyst. The mixture is then dried by heating it in a reducing atmosphere (e.g. H₂ or H₂/N₂), or reduced by adding a reducing agent (e.g. adding a borohydride to the mixture).

In a fourth aspect, the present invention provides a galvanic cell, such as a fuel cell or a battery or a redox flow battery comprising the catalyst according to the second aspect, or the electrode according to the third aspect. In preferred embodiment of the fourth aspect, the battery is a metal/air battery or a redox flow battery which uses oxygen reduction or evolution as one of the electrode reactions.

In a fifth aspect, the present invention provides an electrolytic cell, for instance, a chlorine evolution cell comprising the catalyst according to the second aspect, or the electrode according to the third aspect.

In a sixth aspect, the present invention provides an oxygen sensor comprising the catalyst according to the second aspect, or the electrode according to the third aspect.

In a seventh aspect, the invention relates to a method for reducing oxygen, wherein the method is carried out in the presence of a catalyst according to the first aspect.

### EXAMPLES

Throughout the Examples, if not mentioned otherwise, chemicals were used as received. Acidic and alkaline solutions were made by diluting the concentrated reagent to the necessary degree. (NH₄)₂S₂O₈ (98% Sigma-Aldich), 1,5-Diaminonaphtalene (97% Alfa Aeser), 1,8-Diaminonaphtalene (98% Sigma-Aldrich), HCl (37% Sigma-Aldrich), H₂SO₄, NaOH (97% Sigma-Aldrich), 9-Aminoacridine (hydrochloride monohydrate 98% Sigma-Aldrich), Propylene Carbonate (99.7% Sigma-Aldrich), 1,2-Diaminobenzene (99% Sigma-Aldrich), 2,6-Diaminopyridine (98% Sigma-Aldrich), 2,2′-Dithiodianiline (97% Sigma-Aldrich), Nafion (5% in lower aliphatic alcohols) (Sigma-Aldrich), Methanol (ACS Grade VWR), Pt/C (60% Pt on Vulcan XC-72) (Johnson Matthey). Gases for fuel cell tests were all N6.0 grade, but air which was from an oil-free air-compressor, though having passed through research grade filters.

### Example 1

### Preparation of Various Catalysts According to the Invention

### Example 1.1

Catalyst synthesis (ODIN): 1,5-Diaminonaphtalene (500 mg, 3.16 mmol) and (NH₄)₂S₂O₈ (500 mg, 2.19 mmol) are dissolved and or dispersed in Ethanol (50 mL). The mixture is let to stir for 24 h at room temperature. Then, the mixture is heated to 80° C. in order to completely evaporate the solvent. The resulting residue is heated in the tube furnace to 1000° C. at a heating rate of 20° C./min for 2 h in a nitrogen atmosphere at 1 atm.

### Example 1.2

Catalyst synthesis (ODINb): 1,2-Diaminobenzene (500 mg, 4.63 mmol) and (NH₄)₂S₂O₈ (500 mg, 2.19 mmol) are dissolved and or dispersed in Ethanol (50 mL). The mixture is let to stir for 24 h at room temperature. Then, the mixture is heated to 80° C. in order to completely evaporate the solvent. The resulting residue is heated in the tube furnace to 1000° C. at a heating rate of 20° C./min for 2 h in a nitrogen atmosphere at 1 atm.

### Example 1.3

Catalyst synthesis (ODINp): 1,2-Diaminopyridine (500 mg, 4.58 mmol) and (NH₄)₂S₂O₈ (500 mg, 2.19 mmol) are dissolved and or dispersed in Ethanol (50 mL). The mixture is let to stir for 24 h at room temperature. Then, the mixture is heated to 80° C. in order to completely evaporate the solvent. The resulting residue is heated in the tube furnace to 1000° C. at a heating rate of 20° C./min for 2 h in a nitrogen atmosphere at 1 atm.

### Example 1.4

Catalyst synthesis (n-ODIN): 1,5-Diaminonaphtalene (432 mg, 2.73 mmol) is dissolved in proplylene carbonate (20 mL) at 0° C. and the solution is added to an aqueous solution of 1M HNO₃ (15 mL) at 0° C. and magnetically stirred for 2 h. Ammonium persulfate (912 mg, 4.00 mmol) is added to 1M HNO₃ (60 mL) at 0° C., and then this is added dropwise to the 1,5-Diaminonaphtalene solution. Then this mixture of 1,5-Diaminonaphtalene and Ammonium persulfate is let to stir at around 200 rpm for 22 h at 5° C. The solid phase is isolated by centrifugation and washed with an excess of distilled water and ethanol. The resulting solid is heated in a tube furnace to 1000° C. at a heating rate of 20° C./min for 2 h in a nitrogen atmosphere at 1 atm.

### Example 1.5

Catalyst synthesis (ODINa): 2,2′-Dithiodianiline (500 mg, 2.01 mmol) and (NH₄)₂S₂O₈ (500 mg, 2.19 mmol) are dissolved and or dispersed in Ethanol (50 mL). The mixture is let to stir for 24 h at room temperature. Then, the mixture is heated to 80° C. in order to completely evaporate the solvent. The resulting residue is heated in the tube furnace to 1000° C. at a heating rate of 20° C./min for 2 h in a nitrogen atmosphere at 1 atm.

### Example 2

The ability of catalysts 1.1 to 1.5 from Example 1 to electrochemically reduce oxygen was tested in alkaline and acidic conditions, and the evolution of hydrogen peroxide was measured. These activities were compared to that of platinum supported on carbon.

### Methods and Materials

The catalytic activity of the various catalysts was tested using a Rotating Ring Disk Electrode, RDE (Pine Instruments, model AFE6RIAU employing a mirror polished glassy carbon disk) in O₂ saturated electrolyte solutions. Catalysts 1.1 to 1.5 were deposited on the glassy carbon disk following a procedure published in the literature (Schmidt, T. J. et al, Journal of the Electrochemical Society 1998, 145 (7), 2354-2358). These activities were compared to a reference platinum catalyst, which was a 60 wt % Pt/C catalyst from Johnson Matthey. A rotator from Pine Instruments, model AFMSRCE was used to rotate the RRDE. Electrode rotation speed: 1600 rpm, step potential 30 mV and waiting time of 30 s. Catalyst loading on the glassy carbon RRDE tip: 750 μg cm⁻²_{Disk}, but for platinum which is 30μ_{Pt} cm⁻²_{Disk}. Oxygen saturated solution at 1 bar atmospheric pressure. An RHE reference electrode was used in the cell (Gaskatel HydroFlex). The reference electrode was ionically connected to the main compartment of the electrochemical cell via a Luggin-Haber-Capillary. A glassy carbon rod was used as counter electrode and ionically connected to the main compartment of the cell through a porous frit. A potentiostat (Autolab, model PGSTAT20) was used for potential or current control during the electrochemical measurements.

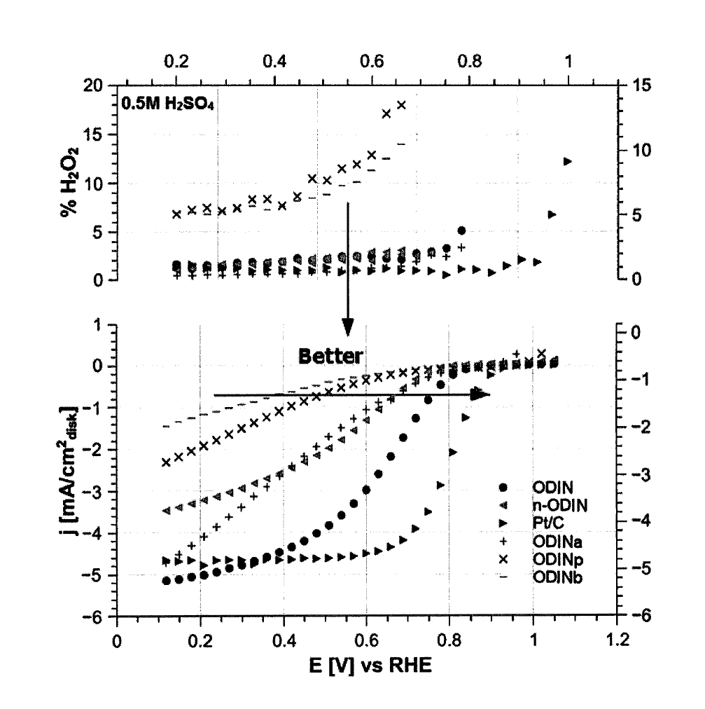

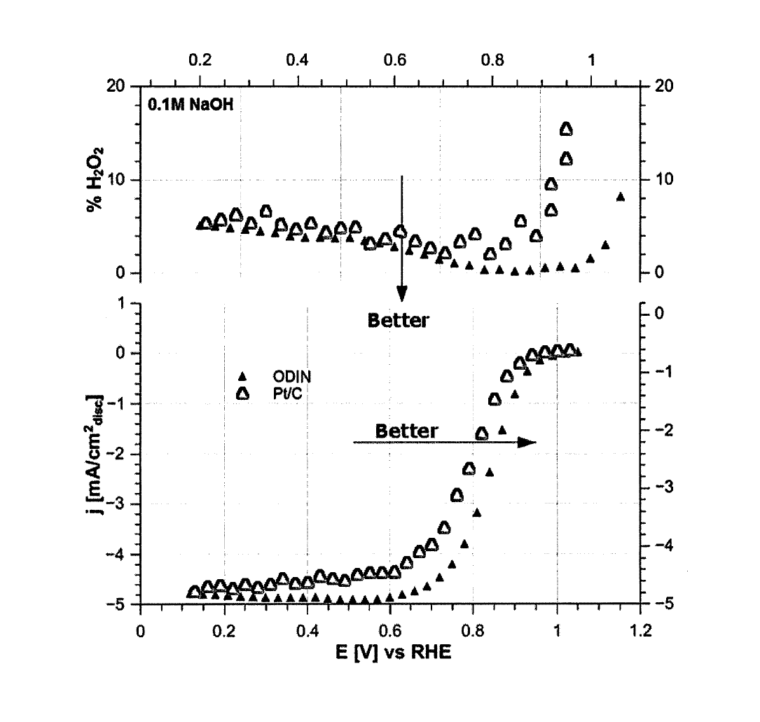

The catalytic activity of each of the catalysts was measured in acidic conditions (0.5M H₂SO₄; results in FIG. 1) and alkaline conditions (0.1M NaOH; results in FIG. 2).

### Results

FIGS. 1 and 2 illustrate the performance of selected catalysts synthesized in an ex situ rotating disk electrode experiment, where the arrows highlight the direction towards where the oxygen reduction reaction is better catalysed (i.e. higher activity catalyst).

It can be seen that the ODIN catalyst has comparable activity to the platinum reference catalyst in acidic conditions, and even out performs the platinum catalyst in alkaline conditions. The percentage of hydrogen peroxide generated on most of the catalysts and specifically on the ODIN catalyst, is below 6% in both environments.

### Example 3

The activity of an exemplary catalyst of the invention was tested in a single Polymer Electrolyte Fuel Cell, and compared to that of a platinum catalyst.

### Materials and Methods

In both PEFCs, a Membrane Electrode Assembly (MEA) was prepared as per a procedure described in the literature (Paganin, V. A.; et al, Journal of Applied Electrochemistry 1996, 26 (3), 297-304). The polymeric electrolyte was a Nafion™ 212 membrane (Ion Power). The ODIN catalyst (catalyst 1.1) was quantitatively deposited on a 5 cm² gas diffusion layer (AVCarb GDS2230 from AvCarb). The platinum cathode was a Johnson Matthey Reformate Cathode Electrode, having a loading of 0.4 mg_{Pt} cm⁻²_{electrode} (from Alfa Aesar). A commercial electrode was used in both PEFCs as the anode (Johnson Matthey Reformate Cathode Electrode, having a loading of 0.4 mg_{Pt} cm⁻²_{electrode}). All single PEFC tests refer to a 5 cm² in electrode area. The lifetime tests and polarization curves were performed utilizing an electronic load (Kikusui KFM2150). Gases were humidified via a humidification system from Fuel Cell Technologies, Inc.

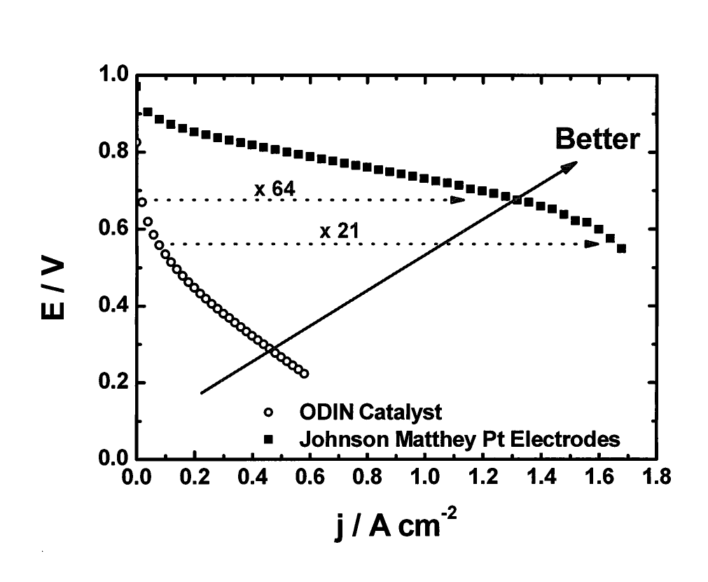

Gas flow rates, H₂/Air 150 ccm/600 ccm under a back pressure of 2 bars gauge on both electrodes. Cell and humidification water bottles temperature at 80° C. Ambient pressure: 1 bar. Results shown in FIG. 3.

### Results

FIG. 3 shows that the ODIN catalyst performs well in a single polymer electrolyte fuel cell (PEFC), with arrow highlighting the direction towards where the performance is better. The catalyst of the invention is close in performance to the reference platinum catalyst.

### Example 4

The response of a catalyst of the invention towards the oxygen reduction reaction was tested in the presence and in the absence of methanol.

### Materials and Methods

A Rotating Disk Electrode was used to test the activity of the ODIN catalyst (catalyst 1.1) in the absence and in the presence of 1M methanol. The RDE and electrochemical equipment used was as described in Example 2.

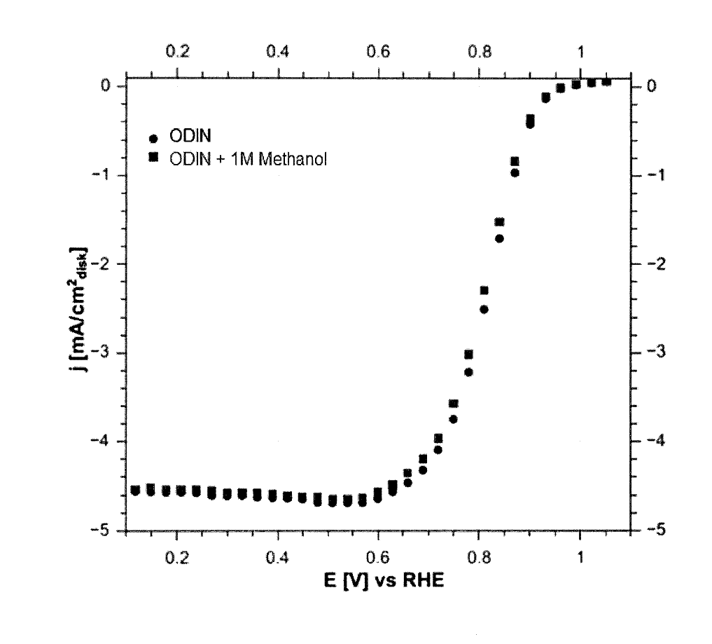

Electrode rotation speed: 1600 rpm, step potential 30 mV and waiting time of 30 s. Catalyst loading on glassy carbon RRDE tip: 750 μg cm⁻². Oxygen saturated solutions at 1 bar atmospheric pressure. Results shown in FIG. 4.

### Results

FIG. 4 shows that the catalyst is tolerant to methanol, in a rotating disk electrode experiment.

### Example 5

The tolerance of a catalyst of the invention towards various poisons (chlorine and chloride ions, hydrogen sulphide, toluene and benzene) was tested.

### 5.1 Tolerance Towards Chloride

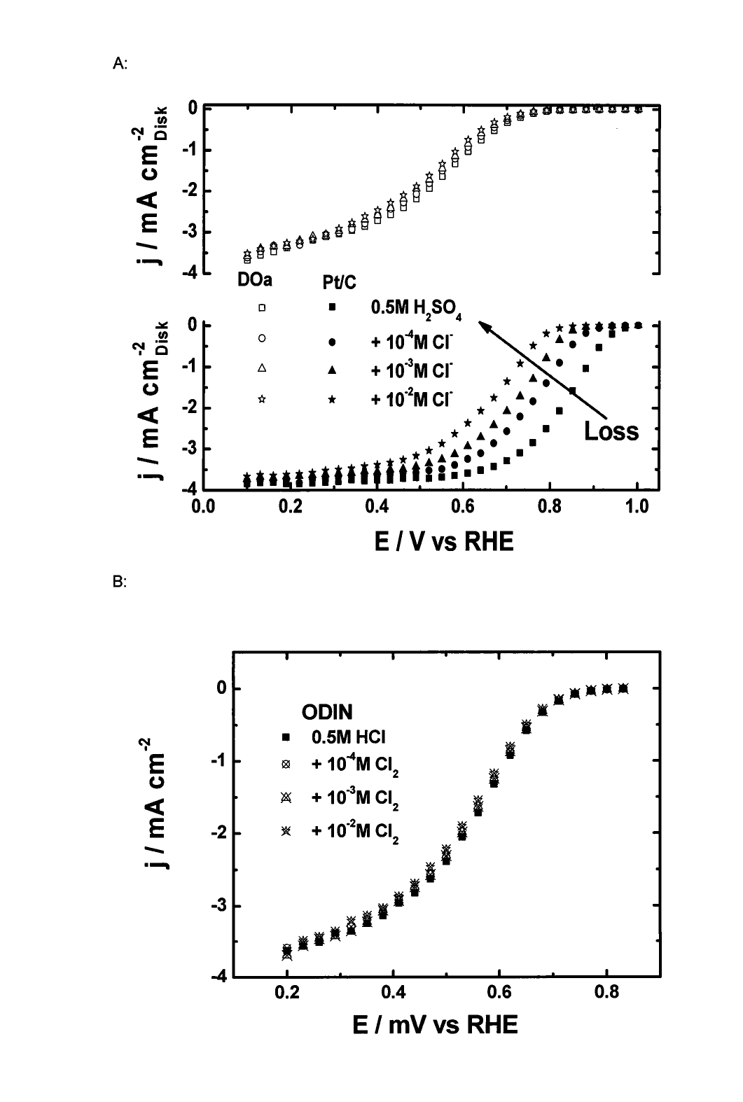

A Rotating Disk Electrode was used to test the activity of the ODIN catalyst (catalyst 1.1) in the presence of various concentrations of chloride ions, Cl⁻ (10⁻⁴M, 10⁻³M and 10⁻²M chloride). The RDE and electrochemical equipment was as described in Example 2. Electrolyte: 0.5M H₂SO₄. Electrode rotation speed: 900 rpm, step potential 30 mV and waiting time of 30 s. Catalyst loading on glassy carbon RDE tip: 750 μg cm⁻²_{Disk}, but for platinum which is 30 μ_{Pt} cm⁻²_{Disk}. Oxygen saturated solutions at 1 bar atmospheric pressure. Results shown in FIG. 5A.

FIG. 5a shows that the catalyst of the invention is capable of reducing oxygen in the presence of chloride ions. This demonstrates that the catalysts of the invention have tolerance towards chloride ions.

### 5.2 Tolerance Towards Chlorine

A Rotating Disk Electrode was used to test the activity of the ODIN catalyst (catalyst 1.1) in the presence of various concentrations of chlorine (10⁻⁴M, 10⁻³M and 10⁻²M chlorine). The activity of a platinum catalyst was assessed under the same conditions. The RDE and electrochemical equipment in this experiment were as described in Example 2. Electrolyte: 0.5M HCl. Electrode rotation speed: 900 rpm, step potential 30 mV and waiting time of 30 s. Catalyst loading on glassy carbon RDE tip: 750 μg cm⁻²_{Disk}, but for platinum which is 30μ_{Pt} cm⁻²_{Disk}. Oxygen saturated solutions at 1 bar atmospheric pressure. Results shown in FIG. 5B.

FIG. 5B illustrates the tolerance of the catalyst of the invention towards chloride, in a rotating disk electrode experiment. The catalyst of the invention out-performs the reference platinum electrode under the same conditions, thereby indicating a higher tolerance towards chlorine.

### 5.3 Tolerance Towards Hydrogen Sulphide, Benzene and Toluene

The fuel cell configuration as described in Example 3 was used in each of the tolerance tests.

The contaminated gas streams were achieved by mixing pure air with a N₂ or Air stream containing the desired substance (H₂S, Benzene or Toluene). The gas stream containing contaminants was injected without humidification to the main gas stream (pure air), which were already humidified. For the experiment where hydrogen sulphide were employed, 50 ccm of 1000 ppm H₂S in balance of Nitrogen (from Air Products) was mixed with 550 ccm of Air, reaching a final flow rate of 600 ccm, containing 83 ppm of H₂S. For when Benzene and Toluene was utilized, an Air stream (50 ccm) was flowed through a solution of either Benzene (Benzene AnalaR Normapur from VWR) or Toluene (Toluene 99.8% from Sigma Aldrich) prior to mixing with 550 ccm or Air. The concentration of Toluene and Benzene in the 50 ccm Air stream was verified by the use of a Benchtop UV-Vis Spectrometer (Perkin Elmer Lambda 25). For this experiment 50 ccm or Air was flowed through either a Benzene or Toluene pure solution and feed into a quartz flow cell in the spectrometer, by recording the absorbance of the characteristic peaks for Benzene and Toluene the respective concentrations in the gas stream could be determined. Other gases utilized on this study were, Nitrogen BIP plus-X47S from Air products, compressed air, Oxygen Ultra-Pure-X47S from Air Products and Hydrogen BOC grade N6.0.

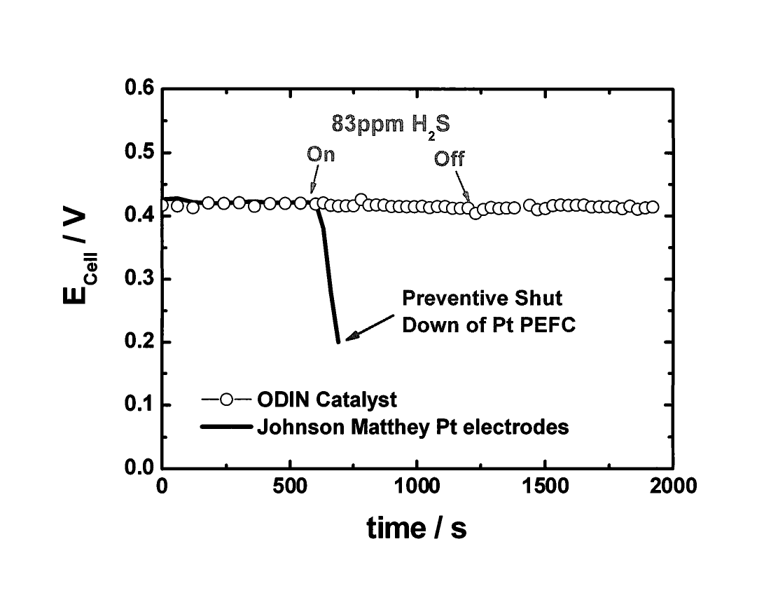

Gas flow rates, H₂/Air 150 ccm/600 ccm. Cell and humidification water bottles temperature at 80° C. Current densities applied to cell through electronic load during lifetime test for the ODIN based single PEFC was 0.05 A cm⁻²_{electrode} and for Platinum based single PEFC was 1.7 A cm⁻²_{electrode}. Ambient pressure 1 bar, with no back pressure applied. Results shown in FIGS. 6 to 8.

FIG. 6 shows the performance of the catalyst during a challenging experiment in a single PEFC, or a lifetime test while the catalyst is exposed to hydrogen sulphide. The results in FIG. 6 also show that, in contrast to the present catalyst, the platinum catalyst is substantially affected by hydrogen sulphide. In fact, the fuel cell test station shut down virtually immediately upon introduction of the hydrogen sulphide into the fuel stream (single point indicates catastrophic drop in cell voltage).

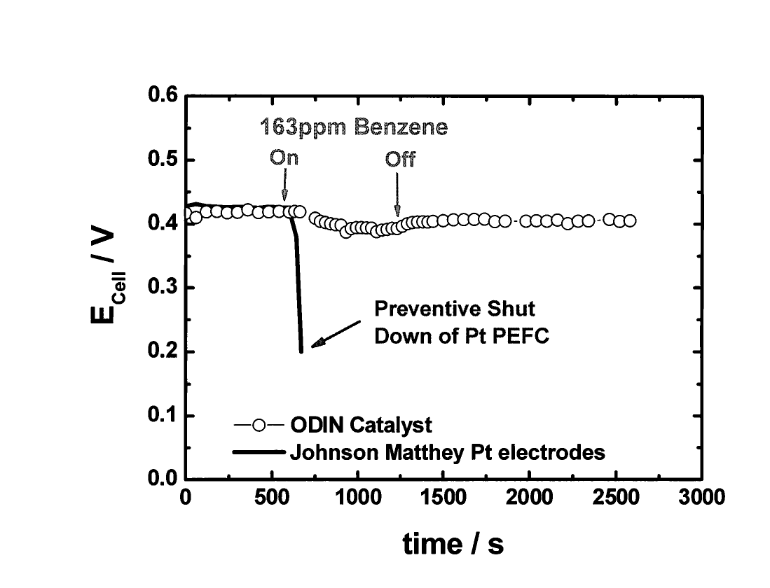

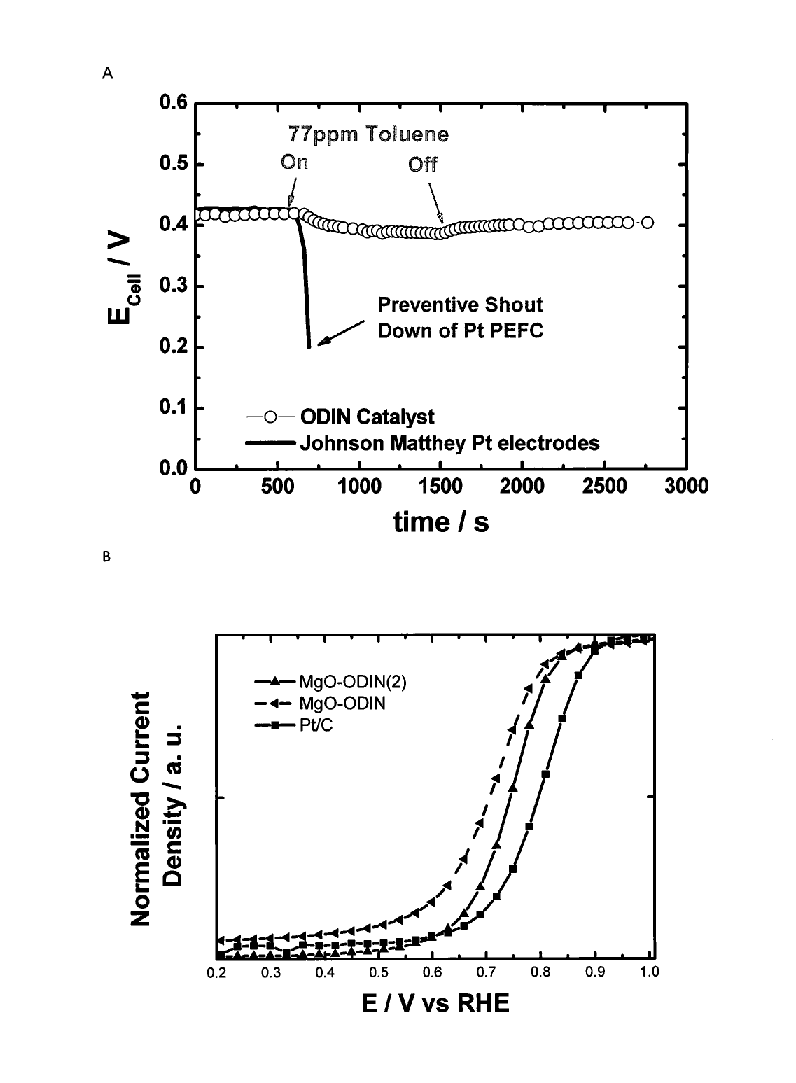

FIGS. 7 and 8A shows the performance of the catalyst in a single PEFC while the catalyst is exposed to Benzene and Toluene. Similarly to FIG. 6, the platinum catalyst is substantially affected by toluene and benzene, and the fuel cell test station shut down virtually immediately upon introduction of the poisons. The activity of the catalyst of the invention drops slightly upon the introduction of benzene and toluene, however, the activity increases again when the gas stream containing the poison is shut off.

### Example 6

The following examples demonstrate the synthesis of catalysts of the invention, prepared in the presence of templating agents. The activity of the resulting catalysts towards the oxygen reduction reaction were tested using an RDE.

### Example 6.1

Catalyst synthesis (MgO-ODIN): 1 g of MgO (nanopowder, <50 nm particle size (BET)) Sigma Aldrich) is ultrasonically dispersed in 220 mL ethanol and 1,5-Diaminonaphtalene (1 g, 6.32 mmol) is added. The reaction mixture is stirred for 10 minutes. FeCl₂*4H₂O; 98% Sigma-Aldrich (40 mg, 0.201 mmol) is dissolved in 20 mL ethanol and added to the reaction mixture. (NH₄)₂S₂O₈ (1 g, 4.38 mmol) is dissolved in 10 mL H₂O and added to the reaction mixture. The mixture is let to stir for 24 h at room temperature. Then the solvent is removed under reduced pressure with a rotary evaporator at 40 C. The resulting residue is heated in the tube furnace to 950° C. at a heating rate of 20° C./min for 2 h in a nitrogen atmosphere at 1 atm. The product is then subjected to reflux in 100 mL of 0.5M H₂SO₄ for 8 h. The residue is filtered, washed and dried overnight at 60 C.

### Example 6.2

Synthesis of the catalyst MgO-ODIN(2): 100 mg of the catalyst MgO-ODIN (Example 2.1) is heated in the tube furnace to 950° C. at a heating rate of 20° C./min for 2 h in a nitrogen atmosphere at 1 atm.

### Example 6.3

A Rotating Disk Electrode was used to test the activity of the catalysts of Examples 6.1 and 6.2. These activities were compared to a reference platinum catalyst. The RDE and electrochemical equipment was as described in Example 2, and the catalysts of the invention were deposited using the same method as Example 2. The catalytic activity of each of the catalysts was measured in acidic conditions (0.5M H₂SO₄; results in FIG. 8B). Rotation Speed: 1600 rpm, Catalyst Loading: 750 μg/cm² except Pt/C: 60 μg_{Pt}/cm², 0.5M H₂SO₄, O₂-saturated.

### Example 7

The following examples demonstrate the synthesis of catalysts of the invention, prepared in the presence of non-precious metal salts. The activity of the resulting catalysts towards the oxygen reduction reaction were tested using an RDE.

### Chemicals:

Iron(II) chloride tetrahydrate 99% (Sigma Aldrich), Cobalt(II) chloride hexahydrate 98% (Sigma-Aldrich), Manganese(II) chloride 99% (Sigma-Aldrich), Chromium(III) chloride hexahydrate 98% (Sigma-Aldrich), Ruthenium(III) chloride (Sigma Aldrich) Ru content 45-55%, Rhodium(III) chloride 98% (Sigma-Aldrich), Iridium(III) chloride hydrate 99.9% (Alfa Aesar).

### Example 7.1

### Catalyst Synthesis (Fe-ODIN)

In a 250 mL round bottom flask, 1,5-Diaminonaphtalene (1 g, 6.32 mmol) was dissolved in Ethanol (220 mL). A solution of FeCl₂*4H₂O (40 mg, 0.201 mmol) dissolved in ethanol (20 mL) was added to the solution. After 10 Minutes, NH₄S₂O₈ (1 g, 4.38 mmol) dissolved in H₂O (10 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Fe-ODIN (354 mg) is ready to use.

### Example 7.2

### Catalyst Synthesis (Co-ODIN)

In a 250 mL round bottom flask, 1,5-Diaminonaphtalene (1 g, 6.32 mmol) was dissolved in Ethanol (220 mL). A solution of CoCl₂*6H₂O (40 mg, 0.193 mmol) dissolved in ethanol (20 mL) was added to the solution. After 10 Minutes NH₄S₂O₈ (1 g, 4.38 mmol) dissolved in H₂O (10 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Co-ODIN (354 mg) is ready to use.

### Example 7.3

### Catalyst Synthesis (Cr-ODIN)

In a 100 mL round bottom flask, 1,5-Diaminonaphtalene (400 mg, 2.53 mmol) was dissolved in Ethanol (88 mL). A solution of CrCl₃*6H₂O (20.0 mg, 0.0769 mmol) dissolved in ethanol (8 mL) was added to the solution. After 10 Minutes NH₄S₂O₈ (400 mg, 1.75 mmol) dissolved in H₂O (4 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Cr-ODIN (148 mg) is ready to use.

### Example 7.4

### Catalyst Synthesis (Mn-ODIN)

In a 250 mL round bottom flask, 1,5-Diaminonaphtalene (1 g, 6.32 mmol) was dissolved in Ethanol (220 mL). A solution of MnCl₂ (22.9 mg, 0.182 mmol) dissolved in ethanol (20 mL) was added to the solution. After 10 Minutes NH₄S₂O₈ (1 g, 4.38 mmol) dissolved in H₂O (10 mL) was also added. The mixture was stirred for 24 h. The solvent was removed under reduced pressure and the remaining black powder is subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Mn-ODIN (350 mg) is ready to use.

### Example 7.5

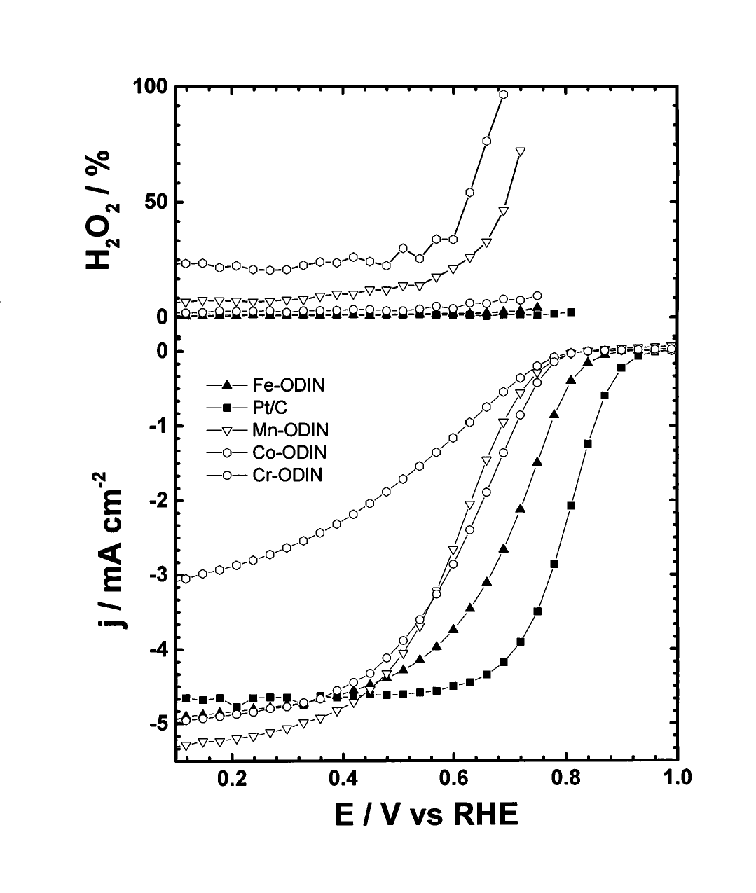

A Rotating Disk Electrode was used to test the activity of the catalysts of Examples 7.1 to 7.4. These activities were compared to a reference platinum catalyst. The RDE and electrochemical equipment was as described in Example 2, and the catalysts of the invention were deposited using the same method as Example 2. The catalytic activity of each of the catalysts was measured in acidic conditions (0.5M H₂SO₄; results in FIG. 9). Rotation Speed: 1600 rpm, Catalyst Loading: 750 μg/cm² except Pt/C: 60 μg_{Pt}/cm², 0.5M H₂SO₄, O₂-saturated, Ring Potential: 1.5V vs RHE.

### Example 8

The following examples demonstrate the synthesis of catalysts of the invention, prepared in the presence of precious metal salts. The activity of the resulting catalysts towards the oxygen reduction reaction were tested using an RDE.

### Example 8.1

### Catalyst Synthesis (Ir-ODIN)

In a 250 mL round bottom flask, 1,5-Diaminonaphtalene (400 mg, 2.53 mmol) was dissolved in ethanol (88 mL). A solution of IrCl₃*xH₂O (12.0 mg) dissolved in a mixture of ethanol/H₂O 2:1 (16 mL) was added to the solution. After 10 Minutes NH₄S₂O₈ (400 mg, 1.75 mmol) dissolved in H₂O (8 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Ir-ODIN (148 mg) is ready to use.

### Example 8.2

### Catalyst Synthesis (Rh-ODIN)

In a 250 mL round bottom flask, 1,5-Diaminonaphtalene (1 g, 6.32 mmol) was dissolved in ethanol (220 mL). A solution of RhCl₃*xH₂O (26.3 mg) dissolved in ethanol (20 mL) was added to the solution. After 10 Minutes NH₄S₂O₈ (1 g, 4.38 mmol) dissolved in H₂O (10 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Rh-ODIN (145 mg) is ready to use.

### Example 8.3

### Catalyst Synthesis (Ru-ODIN)

In a 100 mL round bottom flask, 1,5-Diaminonaphtalene (400 mg, 2.53 mmol) was dissolved in ethanol (88 mL). A solution of RuCl₃ (10.0 mg) dissolved in ethanol (8 mL) was added to the solution. After 10 Minutes NH₄S₂O₈ (400 mg, 1.75 mmol) dissolved in H₂O (8 mL) was also added. The mixture was stirred for 24 h. The solvent was removed under reduced pressure and the remaining black powder was subjected to heat treatment in the tube furnace to 950° C. at a heating rate of 20° C./min for 2 h while supplying a constant stream of inert nitrogen gas. The resulting black powder was refluxed for 8 h in 0.5M H₂SO₄ to remove residual metal. After filtering and drying in the oven at 60° C. over night, the catalyst Ru-ODIN (147 mg) is ready to use.

### Example 8.4

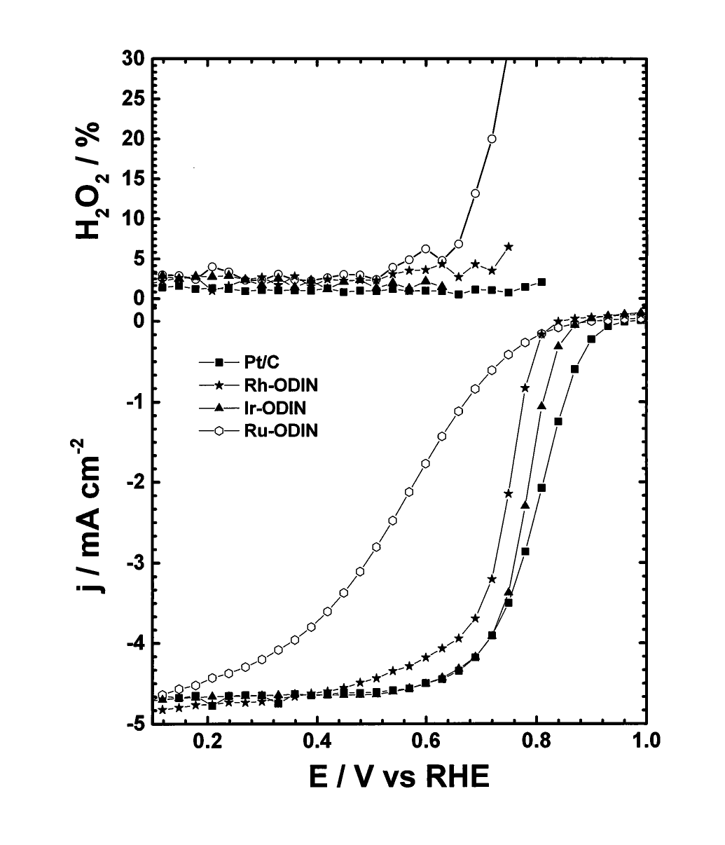

A Rotating Disk Electrode was used to test the activity of the catalysts of Examples 8.1 to 8.3. These activities were compared to a reference platinum catalyst. The RDE and electrochemical equipment was as described in Example 2, and the catalysts of the invention were deposited using the same method as Example 2. The catalytic activity of each of the catalysts was measured in acidic conditions (0.5M H₂SO₄; results in FIG. 10). Catalyst Loading: 750 μg/cm² except Pt/C: 60 μg_{Pt}/cm², 0.5M H₂SO₄, O₂-saturated, Ring Potential: 1.5V vs RHE.

### Example 9

The following example demonstrates the use of a catalyst of the invention as a support for platinum, and its use as a catalyst for the oxygen reduction reaction.

### Example 9.1

### Synthesis of the Catalyst Pt—Fe-ODIN

Modified literature procedure for Pt deposition on carbon black (G. Yu, W. Chen, J. Zhao and Q. Nie, J Appl Electrochem, 2006, 36, 1021-1025):

2.0 ml of a 0.05M H₂PtCl₆*H₂O solution in ethylene was added to 50 mL ethylene glycol. 40 mg of Fe-ODIN (catalyst of Example 7.1) was added and the mixture was suspended uniformly in an ultrasonic bath for 5 minutes. The mixture was then refluxed at 165° C. over an oil bath for 2.75 h to ensure complete reduction. The resulting suspension was filtered and the residue washed with acetone and deionized water.

### Catalyst Loading on RDE:

150 μg_{cat.}cm⁻². Assuming all the platinum present in the reaction mixture is deposited, the catalyst contains max. 25 wt % platinum. Therefore electrode Pt loading is max. 37.5 μg_{Pt}/cm².

### Example 9.2

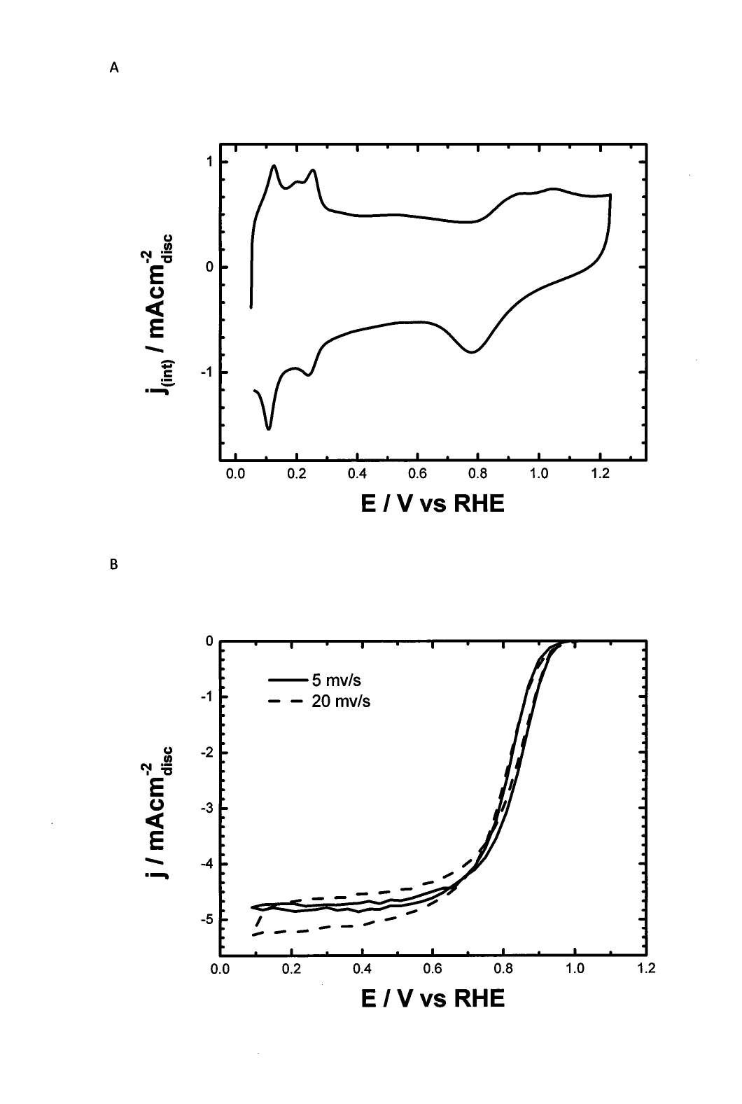

A Rotating Disk Electrode was used to test the activity of the catalysts of Example 9.1. The RDE and electrochemical equipment was as described in Example 2, and the catalyst was deposited using the same method as Example 2. The catalytic activity of the catalyst was measured in acidic conditions (0.5M H₂SO₄). The potential was cycled between 0.05V and 1.23V versus RHE until a stable voltammogram was obtained, and then the integrated current was recorded. Scan Rate: 20.0 mV/s, Loading: 150 μg_{cat.}/cm²=37.5 μg_{Pt}/cm². Results shown in FIG. 11A.

### Example 9.3

A Rotating Disk Electrode was used to test the activity of the catalysts of Example 9.1. The activity of this catalyst was compared to a reference platinum catalyst. The RDE and electrochemical equipment was as described in Example 2, and the catalyst of the invention was deposited using the same method as Example 2. The catalytic activity of the catalyst was measured in acidic conditions (0.5M H₂SO₄; results in FIG. 11B). Catalyst Loading: 750 μg/cm² except Pt/C: 60 μg_{Pt}/cm², 0.5M H₂SO₄, O₂-saturated, Ring Potential: 1.5V vs RHE.

### Example 10

The following example provides a further catalyst of the invention, and demonstrates its use as a catalyst for the oxygen reduction reaction.

### Example 10.1

### Preparation of Catalyst T0 (Thionine Acetate)

400 mg of Thionine acetate (Sigma Aldrich) was dissolved in 100 mL Ethanol. NH₄S₂O₈ (400 mg, 1.75 mmol) was added to the mixture and was stirred for 24 h. The solvent was then removed under reduced pressure and the residue was subjected to heat treatment in the tube furnace to 950° C. at a heating rate of 20° C./min for 2 h while supplying a constant stream of inert nitrogen gas. The resulting black powder was refluxed for 8 h in 0.5M H2SO4 to remove residual metal. After filtering and drying in the oven at 60° C. over night, the catalyst T0 (98 mg) is ready to use.

### Example 10.2

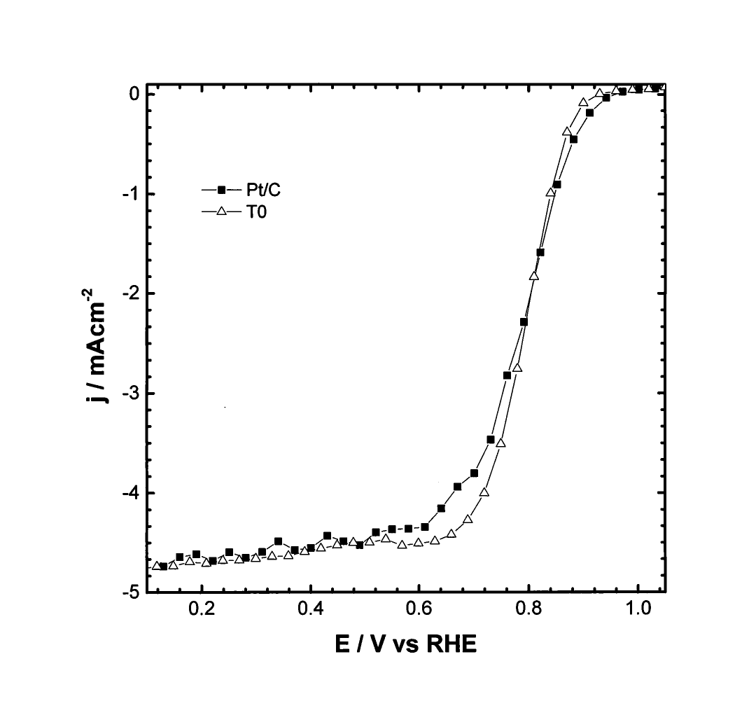

A Rotating Disk Electrode was used to test the activity of the catalysts of Example 10.1. The activity of this catalyst was compared to a reference platinum catalyst. The RDE and electrochemical equipment was as described in Example 2, and the catalyst of the invention was deposited using the same method as Example 2. The catalytic activity of the catalyst was measured in alkaline conditions (0.1M NaOH; results in FIG. 12). Catalyst Loading: 750 μg/cm² except Pt/C: 60 μg_{Pt}/cm², 0.1 M NaOH, O₂-saturated.

### Example 11

### Example 11.1

Catalyst synthesis (ODIN_N): 1,5-Diaminonaphtalene (432 mg, 2.73 mmol) was dissolved in propylene carbonate (20 mL) at 0° C. and the solution was added to an aqueous solution of 1M HNO3 (15 mL) at 0° C. and magnetically stirred for 2 h, in order to protonate 1,5-Diaminonaphtalene. Ammonium persulfate (912 mg, 4.00 mmol) was added to 1M HNO3 (60 mL) at 0° C., and the Ammonium persulfate solution was added dropwise to the 1,5-Diaminonaphthalene solution. Then the mixture of 1,5-Diaminonaphtalene and ammoniumpersulfate was stirred at around 200 rpm for 22 h at 5° C. The poly-(DAN) nanospheres formed were isolated by centrifugation and washed with an excess of distilled water and ethanol, to remove the water-soluble oligomers, residual oxidant and monomer. The resulting black powder was heated in the tube furnace under a constant stream of N2 to 1000° C. at a heating rate of 20° C./min for 2 h. The black product was refluxed for 8 h in 0.5M H2SO4. After filtering and drying in the oven at 60° C. overnight, the catalyst ODIN_N (102 mg) is ready to use.

### Example 11.2

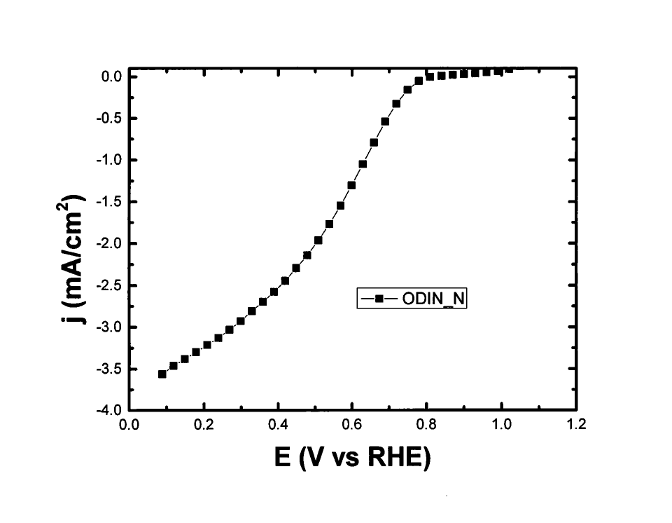

A Rotating Disk Electrode was used to test the activity of the catalysts of Example 10.1. The activity of this catalyst was compared to a reference platinum catalyst. The RDE and electrochemical equipment was as described in Example 2, and the catalyst of the invention was deposited using the same method as Example 2. The catalytic activity of the catalyst was measured in acidic conditions (0.5M H₂SO₄; results in FIG. 14). Catalyst Loading: 750 μg/cm² except Pt/C: 60 μg_{Pt}/cm², 0.5M H₂SO₄, O₂-saturated, Ring Potential: 1.5V vs RHE.

1. A method for preparing a catalyst, comprising the steps of:
a. Providing a reaction mixture comprising a precursor having:
i. one or more aryl or heteroaryl rings and at least one amine group, —NHR, which are attached directly to the aryl or heteroaryl ring(s),
wherein each R is independently selected from H, aliphatic, heteroaliphatic, aryl and heteroaryl; or
ii. at least one heteroaryl ring comprising at least one nitrogen atom and/or at least one sulphur atom;
b. Polymerising the precursor; and
c. Heating the polymer produced by step b) at a temperature of between about 400° C. to about 1200° C., wherein either:
I. When the precursor does not comprise a sulphur atom, the process is carried out in the absence of a microporous support;
II. A templating agent is added to the process prior to conducting step c), said templating agent comprising, consisting essentially of or consisting of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j;
III. The polymerisation step b) involves forming nanospheres of the polymerised precursor; or
IV. An iridium salt is added to the process prior to conducting step c).

2. The method of claim 1, wherein the precursor has one or more aryl or heteroaryl rings and at least one amine group, —NHR, which are attached directly to the aryl or heteroaryl ring(s).

3. The method of claim 1, wherein the precursor has at least two amine groups attached directly to the aryl or heteroaryl ring(s).

4. The method according to claim 1, wherein at least one occurrence of R is H.

5. The method according to claim 1, wherein each occurrence of R is H.

6. The method according to claim 1, wherein the one or more aryl or heteroaryl rings comprises phenyl or a nitrogen-containing heteroaryl ring.

7. The method according to claim 1, wherein the precursor is selected from: 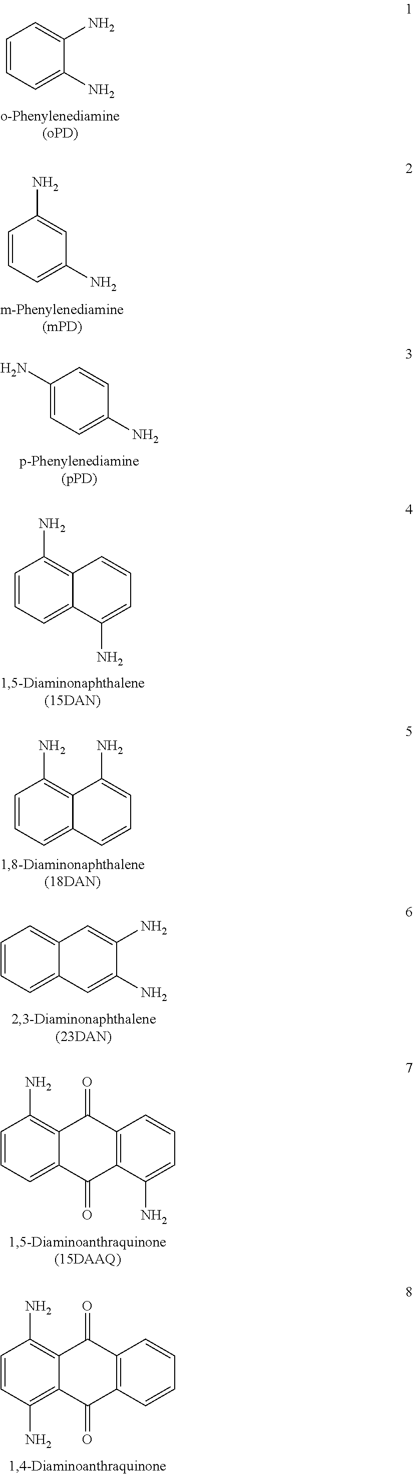 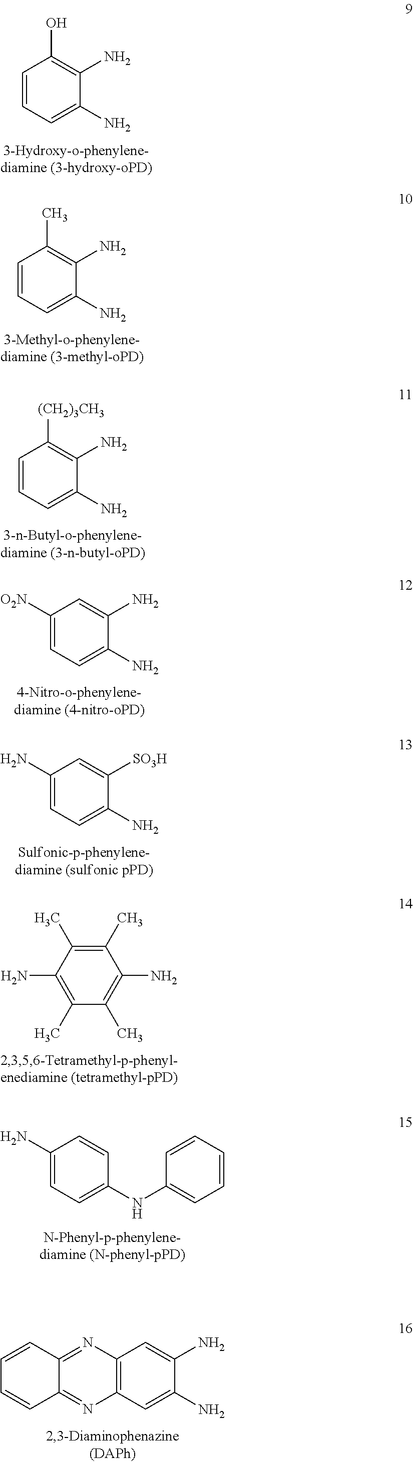 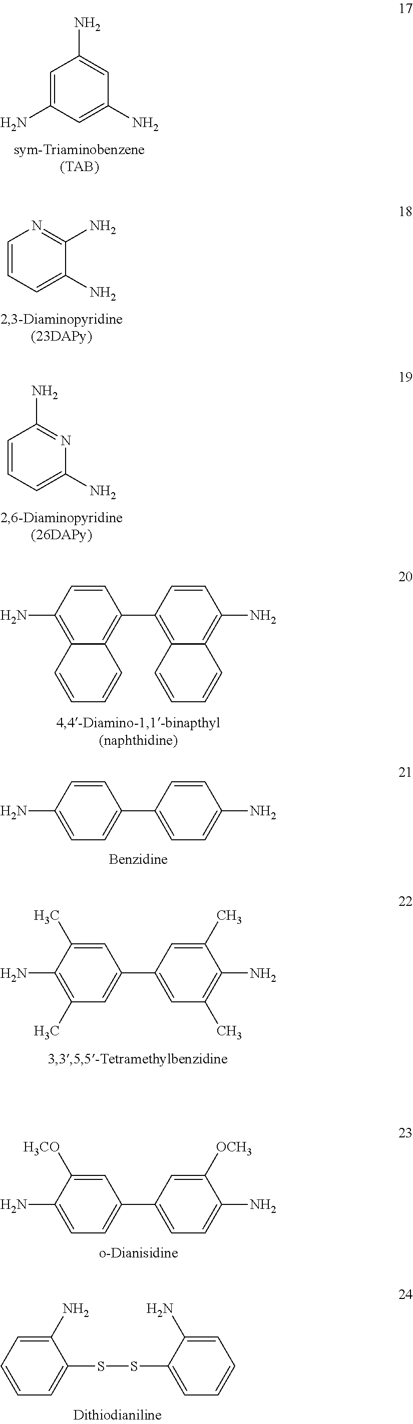 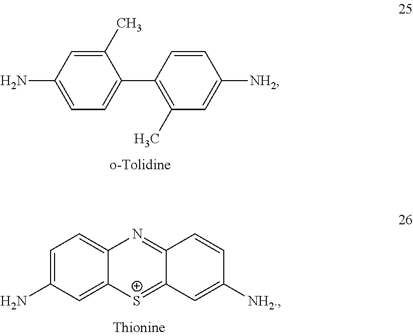 [SMILES: Cc1cc(N)ccc1-c1ccc(N)cc1C ; Nc1ccc2nc3ccc(N)cc3[s+]c2c1]
preferably wherein the precursor is selected from 1,5-diaminonaphthalene, 1,2-diaminobenzene, 1,2-diaminopyridine, 2,2′-dithiodianiline or thionine.

8. The method of claim 1, wherein the at least one heteroaryl ring comprises at least one nitrogen atom.

9. The method of claim 8, wherein the at least one heteroaryl ring comprising at least one nitrogen atom is pyridine or a polypyridine.

10. The method of claim 1, wherein the at least one heteroaryl ring comprises at least one sulphur atom.

11. The method of claim 1, wherein the at least one heteroaryl ring comprises at least one nitrogen atom and at least one sulphur atom.

12. The method according to claim 1, wherein the method is carried out in the absence of a nanoporous support, preferably wherein the nanoporous support is a carbon support material.

13. The method according to claim 12, wherein the carbon support material is selected from carbon black, carbon paper, graphite, carbon nanotubes, carbon nano- or microfibers, and mixtures thereof.

14. The method according to claim 1 wherein the reaction mixture comprises less than 0.5 wt %, preferably less than about 0.1 wt %, even more preferably about 0.08 wt % metal.

15. The method of claim 1, wherein a templating agent is added to the reaction mixture prior to conducting step c), preferably wherein the templating agent is added to the reaction mixture of step a) or wherein the templating agent is added prior to conducting step c).

16. The method of claim 1, wherein the templating agent comprises, consists essentially of or consists of a metal oxide, metal carbonate or metal bicarbonate, preferably wherein the metal is an alkaline earth metal (e.g. Mg or Ca), more preferably wherein the templating agent comprises, consists essentially of or consists of MgO, CaO, MgCO₃, or CaCO₃.

17. The method of claim 1, wherein step b) involves forming nanospheres of the polymerised precursor, preferably by carrying out an emulsion or suspension polymerisation of the precursor.

18. The method of claim 1, wherein a non-precious metal or salt thereof, is added to the reaction mixture prior to conducting step c), preferably wherein the non-precious metal is selected from Fe, Cr, Co and Mn.

19. The method of claim 1, wherein a precious metal or salt thereof, is added to the reaction mixture prior to conducting step c), preferably wherein the precious metal is selected from Rh, Re, Ru, Os, Ir and Pt.

20. The method of claim 1, wherein an iridium salt is added to the reaction mixture prior to conducting step c), preferably wherein the iridium salt is added to the reaction mixture of step a) or wherein the iridium salt is added prior to conducting step c).

21. The method according to claim 1, wherein step b) involves exposing the reaction mixture of step a) to an oxidising agent.

22. The method according to claim 1, wherein step c) is carried out under a heating ramp of from about 5° C. min⁻¹ to about 50° C. min⁻¹.

23. The method according to claim 1, wherein step c) is carried out under vacuum or in the presence of a gas.

24. The method according to claim 23, wherein the gas comprises nitrogen, argon, helium, hydrogen or ammonia.

25. A catalyst obtainable by the method according to claim 1.

26. An electrode comprising the catalyst according to claim 25.

27. The electrode of claim 26, further comprising platinum, preferably wherein said platinum is deposited on said catalyst.

28. A galvanic cell comprising the catalyst according to claim 25, or the electrode according to claim 26.

29. The galvanic cell according to claim 28, wherein the galvanic cell is a fuel cell, a battery or a redox flow battery.

30. An electrolytic cell comprising the catalyst according to claim 25, or the electrode according to claim 26, preferably wherein the electrolytic cell is a chlorine evolution cell.

31. An oxygen sensor comprising the catalyst according to claim 25, or the electrode according to claim 26.
